(19) United States
(12) Patent Application Publication
(10) Pub. No.: US 2025/0296036 A1
(43) Pub. Date: Sep. 25, 2025

(54) COMPOSITIONS AND METHODS FOR CARBON DIOXIDE CAPTURE

(71) Applicant: UNIVERSITY OF SOUTH FLORIDA, Tampa, FL (US)

(72) Inventors: D.Yogi GOSWAMI, Tampa, FL (US); Krishnendu MAITY, Tampa, FL (US); Shreyash BHADIRKE, Tampa, FL (US); Dedeepya RIMMALAPUDI, Tampa, FL (US)

(21) Appl. No.: 19/090,150

(22) Filed: Mar. 25, 2025

Related U.S. Application Data
(60) Provisional application No. 63/569,235, filed on Mar. 25, 2024.
(60) Provisional application No. 63/759,938, filed on Feb. 18, 2025.

(51) Int. Cl. B01D 53/14; B01D 53/02; B01D 53/18; B01D 53/62; B01D 53/75; B01D 53/78; B01D 53/96

(52) U.S. Cl. CPC B01D 53/1493; B01D 53/02; B01D 53/1425; B01D 53/1475; B01D 53/18; B01D 53/62; B01D 53/75; B01D 53/78; B01D 53/96; B01D 2252/2023; B01D 2252/20484; B01D 2252/20494; B01D 2252/504; B01D 2252/602; B01D 2253/102; B01D 2257/504; B01D 2258/06; B01D 2259/4508

(57) ABSTRACT

The present disclosure provides a carbon dioxide absorption composition, which includes a solution of an amino compound in a solvent comprising water and a glycol, as well as a method of using such composition to capture CO₂. The present composition can be particularly advantageous for indoor use, with additional benefit for managing total volatile organic compounds and humidity to enhance overall indoor air quality.

### CROSS-REFERENCE TO RELATED APPLICATIONS

This application claims the benefit of U.S. Provisional Patent Application Ser. Nos. 63/569,235 filed on Mar. 25, 2024 and 63/759,938 filed on Feb. 18, 2025, the contents of which are incorporated by reference herein in their entireties.

### GOVERNMENT SUPPORT

Not Applicable.

### BACKGROUND

The fight against rising CO₂ emissions has become a global race, with researchers focusing on two key fronts: reducing dependence on fossil fuels by making renewable energy more accessible and efficient, and advancing direct air capture (DAC) and carbon capture and storage (CCS) technologies to remove CO₂ from the atmosphere. These efforts are not just about slowing emissions but also about reversing their impact-aiming to achieve net-zero CO₂ emissions by 2050 and preventing global temperatures from exceeding the critical 1.5° C. threshold. According to the Global Monitoring Laboratory of the National Oceanic and Atmospheric Administration, the average global CO₂ concentration in 2023 was 420 ppm (0.042%), which is considered safe for humans. Nevertheless, indoor CO₂ concentrations, especially in workplaces like offices and conference halls, often surpass recommended limits due to occupant's exhalation, placing increased demands on heating, ventilation, and air conditioning (HVAC) systems to maintain indoor air quality. For instance, concentration of CO₂ in an indoor environment can be four to five times higher than the outdoor air. Prolonged exposure to elevated CO₂ levels can lead to health issues such as respiratory acidosis, increased heart rate, cognitive decline, and hypercapnia. The Occupational Safety and Health Administration (OSHA) has established a maximum permissible exposure limit of 5000 ppm over an 8-hour workday. However, relying solely on ventilation to meet this standard can significantly increase the system's carbon footprint. Additionally, research indicates that keeping CO₂ levels below specific thresholds enhances the occupants' cognitive functions and productivity. Therefore, capturing CO₂ is the only viable option to keep the CO₂ level within the acceptable limit in indoor spaces. Since the concentration of CO₂ in indoor air can be four to five times higher than that in outdoor air, capturing CO₂ directly from indoor air can be easier than from outdoor air. The benefits of capturing CO₂ from indoor air are twofold: first, it removes CO₂ from the atmosphere, and second, it improves the health and work efficiency of individuals working indoors.

Thus, there remains a need for alternative agents and devices to effectively capture CO₂ from an indoor setting to improve air quality.

### SUMMARY OF THE INVENTION

Ther present disclosure provides a carbon dioxide absorption composition, methods of using the same, and devices comprising the same.

One aspect of the present disclosure provides a carbon dioxide absorption composition, comprising a solution of an amino compound in a solvent comprising water, a glycol, and a surfactant. As demonstrated herein, the relative proportion of the glycol to the surfactant can enhance the capacity of the present composition for carbon dioxide absorption.

Another aspect of the present disclosure provides a device for carbon dioxide absorption, comprising the carbon dioxide absorption composition disclosed herein; and a chamber in which the carbon dioxide absorption composition is placed.

Another aspect of the present disclosure provides a method of removing carbon dioxide in a gas phase, the method comprising contacting the gas phase with the carbon dioxide absorption composition disclosed herein, so that the carbon dioxide in the gas phase reacts with the amino compound in the carbon dioxide absorption composition to produce a carbon dioxide-enriched composition, thereby reducing content of the carbon dioxide in the gas phase. As a nonlimiting example, the gas phase can include air, such as indoor air.

Another aspect of the present disclosure provides a method of improving indoor air quality, the method comprising: contacting the indoor air with the carbon dioxide absorption composition disclosed herein, such that the carbon dioxide in the indoor air reacts with the amino compound in the carbon dioxide absorption composition to produce a carbon dioxide-enriched composition, thereby reducing content of the carbon dioxide in the indoor air.

### BRIEF DESCRIPTION OF THE DRAWINGS

Further objects, features and advantages of the present disclosure will become apparent from the following detailed description taken in conjunction with the accompanying figures showing illustrative embodiments of the present disclosure. Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A shows the reaction between CO₂ and amine, presence and absence of water.

FIG. 1B shows the regeneration of amine.

FIG. 2A shows CO₂ absorption during the CO₂ absorption process for aqueous MEA, aqueous L-arginine, H₂O-EG-Arg, and H₂O-PG-Arg solution. Absorption 2 refers to the second cycle after the initial absorption-desorption cycle.

FIG. 2B shows TVOC concentration during the CO₂ absorption process for aqueous MEA, aqueous L-arginine, H₂O-EG-Arg, and H₂O-PG-Arg solution. Absorption 2 refers to the second cycle after the initial absorption-desorption cycle.

FIG. 2C shows RH levels during the CO₂ absorption process for aqueous MEA, aqueous L-arginine, H₂O-EG-Arg, and H₂O-PG-Arg solution. Absorption 2 refers to the second cycle after the initial absorption-desorption cycle.

FIG. 3A shows the effect of MW irradiation time on CO₂ desorption for aqueous MEA solution.

FIG. 3B shows the effect of MW desorption time on volume of the solution for aqueous MEA solution.

FIG. 4 shows (a) absorption-desorption performance over ten cycles of aqueous MEA and H₂O-PG-Arg solution. The percentage reduction of the amount of CO₂ absorbed after each absorption process, as well as the cumulative reduction after ten cycles, is shown at the top of the figure. (b) absorption-desorption performance over ten cycles of aqueous MEA and H₂O-PG-Arg solution with trendline.

FIG. 5 shows (a) Reaction rate constant over ten cycles of aqueous MEA and H₂O-PG-Arg solution. The percentage decrease in the rate constant in each absorption process, as well as the cumulative reduction after ten cycles, is shown at the top of the figure. (b) Reaction rate constant over ten cycles of aqueous MEA and H₂O-PG-Arg solution with trendlines.

FIG. 6 shows the experimental setup used for absorption and desorption of CO₂ scrubbing solution (a) Two-neck round bottom flask absorption system (b) MW setup for solution regeneration.

FIG. 7A shows CO₂ separation over time for aqueous MEA, aqueous Arg, H₂O-EG-Arg, and H₂O-PG-Arg solutions.

FIG. 7B shows the reaction kinetics for aqueous MEA, aqueous Arg, H₂O-EG-Arg, and H₂O-PG-Arg solution.

FIG. 8 shows the relative humidity profile for aqueous MEA and aqueous Arg solution. The slope of the line was determined by linear regression.

FIG. 9 shows the Arg crystals after desorption of aqueous Arg solution.

FIG. 10A shows TVOC for H₂O-PG-based Arg solution with and without activated charcoal canister.

FIG. 10B shows relative humidity profile for H₂O-PG-based Arg solution with and without activated charcoal canister.

FIG. 11A shows relative humidity inside the absorption test chamber over time for H₂O-PG-Arg solution.

FIG. 11B shows TVOC levels inside the absorption test chamber over time for H₂O-PG-Arg solution.

### DETAILED DESCRIPTION

The present disclosure relates to compositions, devices, methods for absorbing carbon dioxide (CO₂) from a gas phase, in particular indoor air.

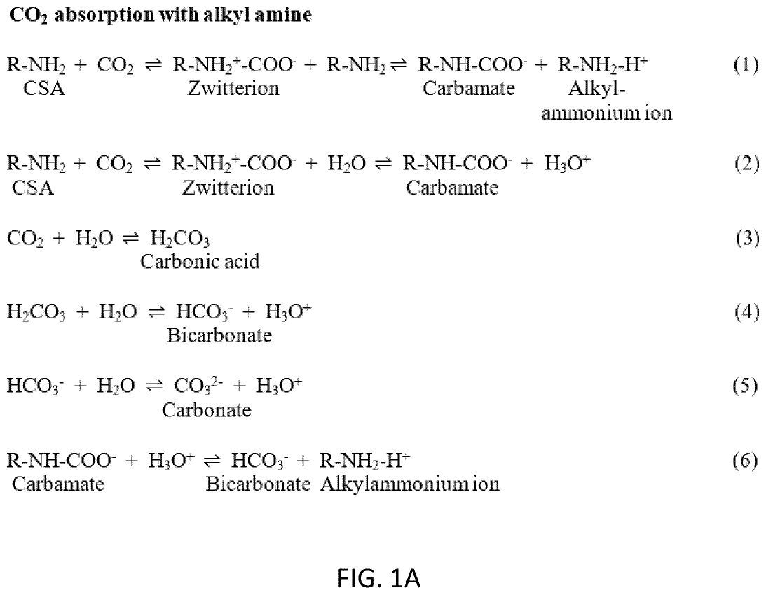

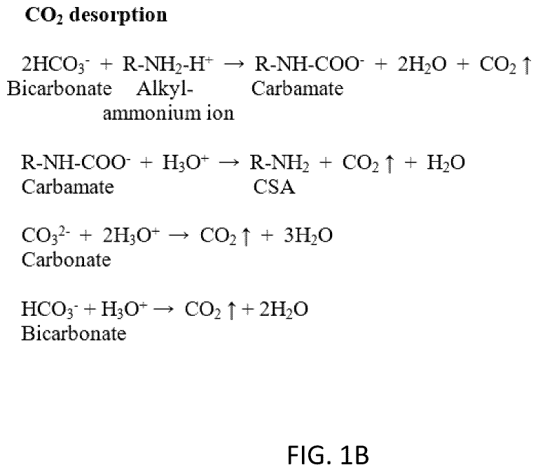

Chemical absorption is one of the most promising technologies for CO₂ capture due to its high selectivity and scalability opportunities. Various absorbing agents were reported, including aqueous alkali solutions, amines, ionic liquids, amine-functionalized adsorbents, and amino acid solutions, to chemically extract CO₂ from air or gas streams. Among these methods, amine-based technology remains the most widely used. Researchers have shown that the interaction between CO₂ and aqueous amines follows the zwitterionic mechanism. The nucleophilic lone pair on the nitrogen atom of the amine attacks the electrophilic carbon of CO₂, forming zwitterionic adduct (R—NH₂⁺—COO⁻), which stabilizes into carbamate (R—NH—COO⁻) and an alkylammonium ion (R—NH₂—H⁺) upon deprotonation (Reaction 1). As absorption progresses, the pH and absorption rate decrease due to the depletion of the CO₂ scrubbing agent (CSA), weakening Reaction. This favors hydration reactions (Reactions 2-5), resulting in the formation of bicarbonate (HCO₃⁻) and carbonate (CO₃²⁻). Additionally, as the pH drops, carbamate formed in Reactions 1 and 2 decomposes into bicarbonate, as shown in Reaction 6. This process is reversible during desorption, as shown in Reactions 7-10. The full sequence of absorption and desorption reactions is outlined in FIGS. 1A-1B.

Alkanolamines are preferred over alkylamines for CO₂ capture due to their higher boiling points and lower volatility, which reduces the emission of VOCs during absorption and desorption processes. Monoethanolamine (MEA) is used as a benchmark solvent due to its affordability, high water solubility, and rapid CO₂ absorption rate. However, it still has drawbacks, such as volatility that can lead to higher TVOC emissions and may limit indoor use, along with a high energy demand for regeneration. Furthermore, it is prone to thermal and oxidative degradation, which results in increased viscosity, solution fouling, and corrosion of downstream equipment. These challenges highlight the need for alternative CSA for indoor CO₂ capture. Aqueous amino acids are emerging as promising alternatives. Known for their high surface tension, they offer comparable CO₂ absorption capacity with negligible vapor pressure and greater resistance to degradation. These properties make them well-suited for capturing CO₂ in indoor applications, providing a viable path forward in overcoming the limitations of conventional absorbents like MEA. Arginine (Arg) specifically offers several advantages over traditional absorbents like MEA, including greater resistance to thermal and oxidative degradation. This allows the Arg solution to undergo multiple absorption-desorption cycles, reducing costs associated with frequent solution replacement. Its higher surface tension also minimizes evaporation losses during both CO₂ capture and release, and its biodegradability makes Arg a more environmentally sustainable option. However, despite these promising attributes, only a limited number of studies have explored the role of Arg in CO₂ capture. No research to date has specifically addressed CO₂ capture from indoor air while simultaneously controlling TVOC and humidity levels. Maintaining optimal levels of both TVOCs and humidity is essential for safeguarding respiratory health and ensuring thermal comfort for occupants.

The present disclosure addresses the deficiencies of previous studies and provides efficient and affordable CO₂ capture compositions, devices, methods. Advantageously, the present compositions and devices can be specifically designed for indoor use, with added functionality for managing TVOCs and humidity to enhance overall indoor air quality.

Concentration of CO₂ in an indoor environment can be four to five times higher than the outdoor air. This higher indoor concentration of CO₂ reduces the work efficiency of individuals working indoors and negatively impacts human health. However, the elevated concentration also makes it easier to capture CO₂ from indoor air. In certain embodiments, the present disclosure demonstrated the performance of monoethanolamine (MEA) and L-arginine (Arg) solutions for indoor carbon dioxide (CO₂) capture through experimental screening. The parameters evaluated include CO₂ absorption and desorption capacity, absorption kinetics, and the impact on relative humidity (RH) and total volatile organic compound (TVOC) concentrations. In particular embodiments, two solvent formulations were studied: one utilizing pure water as the solvent and the other incorporating a water-glycol mixture. The aqueous Arg solution demonstrated minimal to no detectable increase in VOC levels and exhibited lower evaporation rates than the benchmark aqueous MEA solution. Microwave (MW) heating can be utilized to facilitate rapid CO₂ desorption from saturated solutions. The regeneration efficiency, solvent loss, and energy consumption were found to be dependent on the MW desorption time. Optimizing the desorption resulted in faster and almost complete regeneration, minimized solvent loss, and reduced overall energy consumption. The incorporation of glycol minimized evaporation during absorption, decreased the likelihood of complete drying during desorption, and improved solution regeneration. Cyclic absorption-desorption experiments were conducted to evaluate the long-term stability and kinetic performance of the solutions. In representative studies, the water-PG-based Arg solution exhibited a promising performance, with only a 31.24% reduction in CO₂ absorption and a 2.13% decrease in absorption kinetics after ten cycles. In contrast, the aqueous MEA solution showed much larger declines of 54.3% in CO₂ absorption and 34.24% in kinetics. Additionally, the water-PG-based Arg solution resulted in lower volatile organic compound (VOC) levels and provided more effective control over relative humidity. These findings underscore the potential of the water-PG-based Arg solution for cyclic CO₂ absorption and microwave-assisted regeneration processes.

In one aspect, the present disclosure provides a carbon dioxide absorption composition, comprising a solution of an amino compound in a solvent comprising water, a glycol, and a surfactant.

Typically, the amino compound of the present disclosure reacts with CO₂ to form a soluble carbamate, thereby absorbing (or scrubbing) the CO₂ into the solution. The absorbed CO2 can be released in a desorption process that includes hydrolysis of the carbamate and regeneration of the amino compound. Representative chemical reactions involved in the CO2 adsorption and desorption processes include those illustrated in FIGS. 1A-1B. The desorption process can be carried out, for example under heating or microwave irradiation.

Suitable amino compounds for the present composition include, but are not limited to, an alkylamine, an alkanolamine, an amino acid, or a combination thereof. The alkylamine refers to a compound having an amino group (—NH₂) attached to an alkyl group. The term “alkyl” as used herein, means a straight or branched chain saturated hydrocarbon. As non-limiting examples, the alkyl can be a C₁₋₁₀alkyl, such as methyl, ethyl, n-propyl, isopropyl, n-butyl, sec-butyl, isobutyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. The alkanolamine refers to an alkylamine compound further substituted with one or more hydroxyl (—OH) groups. The amino acid refers to compounds having both amino (—NH₂) and carboxylic acid (—COOH) groups, or salts thereof. The amino acids as used herein can include natural or synthetic compounds, such as α-amino acids, β-amino acids, or γ-amino acids.

In some embodiments, the amino compound is an alkanolamine, such as monoethanolamine. In some embodiments, the amino compound is an amino acid, such as a natural amino acid. In some embodiments, the amino compound is arginine.

The glycol of the present composition refers to an organic compound with two hydroxyl (—OH) groups attached to adjacent carbon atoms. For example, the glycol can include a carbon chain and two —OH groups are attached to adjacent carbon atoms of the carbon chain. Suitable glycols can include, for example, ethylene glycol, diethylene glycol propylene, triethylene glycol, propylene glycol, di-propylene glycol, and a mixture thereof. In some embodiments, the glycol is ethylene glycol or propylene glycol. In some embodiments, the glycol is propylene glycol.

The present composition includes a solution of the amino compound dissolved in a solvent, which includes a mixture of water and the glycol. The ratio of the water to the glycol can be about 0.5:1 to about 2:1 by volume. In some embodiments, the ratio of water to the glycol is about 1:1 by volume.

In some embodiments, the amino compound has a concentration of about 500 mM to about 20000 mM in the solution, such as from about 500 mM to about 15000 mM, about 500 mM to about 10000 mM, about 500 mM to about 5000 mM, about 500 mM to about 2000 mM, about 500 mM to about 1000 mM, about 1000 mM to about 15000 mM, about 1000 mM to about 10000 mM, about 1000 mM to about 5000 mM, or about 1000 mM to about 2000 mM. In some embodiments, the amino compound has a concentration of about 500 mM, about 1000 mM, about 2000 mM, about 5000 mM, about 10000 mM, about 15000 mM, or about 20000 mM. In some embodiments, the amino compound is an amino acid having a concentration of about 500 mM to about 2000 mM. In some embodiments, the amino compound is an amino acid having a concentration of about 1000 mM. In some embodiments, the amino compound has a concentration of about 500 mM to about complete saturation in the solution (such as about 1000 mM or about 2000 mM). In some embodiments, the amino compound is a water miscible amine, which may have a concentration of about 1000 mM to about 10000 mM in the solution, such as about 2000 mM, about 5000 mM, or about 8000 mM. In some embodiments, the amino compound is a water miscible amine having a concentration of about 1000 mM.

Suitable surfactants can include, but are not limited to, cationic surfactants, anionic surfactants, amphoteric surfactants, zwitterionic surfactants, nonionic surfactants, and mixtures thereof. In some embodiments, the surfactant includes a nonionic surfactant, such as polyoxyalkylene alkyl ethers, polyoxyalkylene alkenyl ethers, polyoxyalkylene alkyl phenyl ethers, alkyl polyglucosides, fatty acid polyglycerine esters, fatty acid sugar esters, and fatty acid alkanolamides. In some embodiments, the surfactant includes an anionic surfactant, such as a carboxylate-, sulfonate-, or sulfate-based surfactant. In some embodiments, the surfactant includes sodium lauryl sulfate (SLS), sodium laureth sulfate (SLES), linear alkylbenzene sulfonates (LAS), sodium dodecyl sulfate (SDS), alpha olefin sulfonates (AOS), and sulfonated castor oil; the cationic surfactants include cetyltrimethylammonium bromide (CTAB), benzalkonium chloride (BAC), benzethonium chloride, dodecyltrimethylammonium chloride (DTAC), and cetrimonium chloride (CTAC); the non-ionic surfactants include polysorbates (Tween 20, Tween 80), sorbitan esters (Span 20, Span 80), alcohol ethoxylates, polyethylene glycol (PEG) derivatives, cocamide diethanolamine (Cocamide DEA), and cocamide monoethanolamine (Cocamide MEA); and the amphoteric surfactants include cocamidopropyl betaine (CAPB), lauryl betaine, sodium cocoamphoacetate, sodium lauryl amphopropionate, or a combination thereof. In some embodiments, the surfactant is perfluorooctanoic acid (PFOA), sodium dodecyl sulfate (SDS), Triton X-100, or a combination thereof.

In some embodiments, the surfactant has a concentration of about 200 mg/L to about 500 mg/L, such as about 200 mg/L to about 450 mg/L, about 200 mg/L to about 400 mg/L, about 200 mg/L to about 350 mg/L, or about 200 mg/L to about 300 mg/L. In some embodiments, the surfactant has a concentration of about 200 mg/L, about 250 mg/L, about 300 mg/L, about 350 mg/L, about 400 mg/L, about 450 mg/L, or about 500 mg/L. Suitable surfactant concentration can be measured by folds of the critical micelle concentration (CMC) of the surfactant in the solution. In some embodiments, the surfactant has a concentration that is about 4 to about 10 times the CMC, such as about 4 times the CMC, about 5 times the CMC, about 6 times the CMC, about 7 times the CMC, about 8 times the CMC, about 9 times the CMC, or about 10 times the CMC.

The effects of adding surfactants to aqueous amine solutions were previously studied. However, those studies do not examine the implications in a continuous operational setting. The present disclosure provides a deeper analysis of surfactant behavior under real process conditions, which is beyond the scope of earlier reports. Significantly, the present disclosure uncovers insights previously overlooked, making the findings herein uniquely valuable for practical applications.

In some embodiments, the present composition utilizes a 50 ml/50 ml (1:1) water-glycol mixture as a solvent, especially propylene glycol, leveraging the distinct properties of glycol to enhance performance. Glycol reduces solvent volatility, minimizing evaporative losses, which maintains solvent integrity over extended use. Additionally, glycols have lower specific heat capacities, meaning they require less thermal energy to reach the desorption temperature, improving energy efficiency.

The present composition can include one or more glycols in combination with one or more surfactants as described herein to enhance performance for continuous operation. The surfactant can act as a foaming agent to increase CO₂ absorption when the composition contacts CO₂. On the other hand, the glycol can act as a defoamer among its other roles. Further, the present disclosure demonstrates that the incorporation of surfactants and defoamers (such as glycols) can effectively control foam stability. Under continuous operating conditions, excessively stable foam can lead to overflow, causing chemical loss, operational disruptions, and potential safety hazards. Therefore, precisely tuning the foaming behavior is essential when surfactants are present. By adjusting the ratio of surfactants to defoamers, the foam's lifespan can be carefully managed, ensuring it remains transient and does not exceed a controlled level. In some embodiments, the relative proportion of the glycol to the surfactant enhances carbon dioxide absorption. For example, the present composition can include the glycol and the surfactant at a specific relative proportion to create a short-lived foam that enhances CO₂ absorption from a gas phase, such as from indoor air. In some embodiments, a 1:1 ratio of water and glycol was found to be particularly effective, based on the solubility of the CO₂-scrubbing chemicals and a fluorosurfactant concentration that is about 4 to about 10 times the critical micelle concentration (CMC) in water at 25° C.

While many surfactants can be used in the present carbon dioxide absorption composition, fluorosurfactants can be chosen in particular embodiments for their superior ability to reduce surface tension at lower concentrations, enhanced chemical stability over multiple adsorption-desorption cycles, and chemical inertness.

In some embodiments, the amino compound is arginine and the solvent comprises water and propylene glycol in a ratio of about 1:1 by volume.

In some embodiments, the composition includes arginine (e.g., L-arginine), water, and propylene glycol. In some embodiments, the ratio of water and propylene glycol is about 1:1 by volume. In some embodiments, the concentration of arginine (e.g., L-arginine) in water and propylene glycol is about 1 M. In some embodiments, the composition of arginine (e.g., L-arginine), water, and propylene glycol further includes a surfactant selected from perfluorooctanoic acid (PFO), sodium dodecyl sulfate (SDS), and Triton X100. In some embodiments, the composition includes about 1 M arginine (e.g., L-arginine) dissolved in a solvent of water and propylene glycol at a ratio of about 1:1 by volume, and a surfactant selected from perfluorooctanoic acid (PFO), sodium dodecyl sulfate (SDS), and Triton X100.

In some embodiments, the composition includes MEA, water, and propylene glycol. In some MEA composition, the ratio of water and propylene glycol can be about 1:1 by volume. In some embodiments, the MEA composition further includes a surfactant selected from perfluorooctanoic acid (PFO), sodium dodecyl sulfate (SDS), and Triton X100. In some embodiments, the composition includes MEA, water, and propylene glycol at a ratio of about 1:1 by volume, and a surfactant selected from perfluorooctanoic acid (PFO), sodium dodecyl sulfate (SDS), and Triton X100.

In some embodiments, the composition includes MEA, one or more glycols (such as propylene glycol), water, and one or more surfactants (such as fluorosurfactants). In some embodiments, the composition includes arginine (e.g., L-arginine), one or more glycols (such as propylene glycol), water, and one or more surfactants (such as fluorosurfactants).

In some embodiments, the composition includes arginine (e.g., L-arginine), water, ethylene glycol, and a surfactant. In some embodiments, the ratio of water and ethylene glycol is about 1:1 by volume. In some embodiments, the concentration of arginine (e.g., L-arginine) in water and ethylene glycol is about 1 M. In some embodiments, the composition includes about 1 M arginine (e.g., L-arginine) dissolved in a solvent of water and ethylene glycol at a ratio of about 1:1 by volume.

In another aspect, the present disclosure provides a device for carbon dioxide absorption, which comprises the carbon dioxide absorption composition as described herein and a chamber in which the carbon dioxide absorption composition is placed.

The present device can further comprise an inlet connected to the chamber for introducing a gas phase comprising carbon dioxide to react with the carbon dioxide absorption composition in the chamber, thereby reducing content of the carbon dioxide in the gas phase; and a channel connected to the chamber, through which the gas phase with reduced content of carbon dioxide exits the chamber.

The present device can further include other components and accessories, such as a power supply, a monitor, a housing, and a user interface. In some embodiments, the present device can be used to absorb indoor carbon dioxide.

In another aspect, the present disclosure provides a method of removing carbon dioxide in a gas phase. The method can comprise contacting the gas phase with the carbon dioxide absorption composition as described herein, so that the carbon dioxide in the gas phase reacts with the amino compound in the carbon dioxide absorption composition to produce a carbon dioxide-enriched composition, thereby reducing content of the carbon dioxide in the gas phase.

For example, the chemical reactions involved in the CO₂ adsorption process include those illustrated in FIG. 1A. The contact between the gas phase and the carbon dioxide absorption composition can include any form of gas-liquid surface contact. For example, the gas phase can be flowed across the surface of the liquid composition or bubbled through the bulk volume of the liquid composition. Additionally, the gas phase can be introduced to the liquid composition repeatedly through recycling of the gas phase.

The gas phase can be present in an outdoor environment, an indoor environment, or an isolated space (e.g., a sealed container, a chamber with controlled input and output, or a flow path for a gas and/or a fluid). In some embodiments, the gas phase comprises air. The air can include natural air or artificially modified air for animal or human use. In some embodiments, the gas phase is indoor air. The term “indoor” as used herein refers to an enclosed or partially enclosed space for animal or human activities, such as the internal space of a building, a stadium, a laboratory, a room, a residence, an office, a hospital, a vehicle, a ship, a submarine, an aircraft, etc. The indoor air may have a CO₂ level of about 400 ppm to about 5,000 ppm, or higher than 5,000 ppm. In some embodiments, the gas phase comprises more concentrated streams of CO₂. For example, the gas phase with elevated CO₂ content may include a gas product or by-product from a fossil fuel-based power plant, an exhaust gas from a vehicle, or a gas emitted from a source where a biomass is burned.

In another aspect, the present disclosure provides a method of improving indoor air quality. The method can comprise contacting the indoor air with the carbon dioxide absorption composition as described herein, such that the carbon dioxide in the indoor air reacts with the amino compound in the carbon dioxide absorption composition to produce a carbon dioxide-enriched composition, thereby reducing content of the carbon dioxide in the indoor air.

The composition and device as described herein may be particularly suitable for capturing (or scrubbing) CO₂ from indoor air, providing an approach to effectively improve indoor air quality that has not been observed in the art. On the one hand capturing CO₂ from indoor air is beneficial because the concentration of CO₂ in indoor air is much higher than outdoor air. However, it can be also difficult to maintain comfort conditions of temperature and relative humidity (RH) in indoor air. In addition, introduction of additional volatile organic compounds (VOCs) in indoor air should be avoided. Advantageously, the present method may maintain comfort indoor conditions for the occupants while capturing CO₂ from indoor air. Further, by capturing CO₂ from indoor air, the CO₂ levels is maintained below what is unhealthy for occupants.

In some embodiments, the indoor air has a CO₂ level of about 400 ppm to about 5,000 ppm, or higher than 5,000 ppm.

In some embodiments, the method is carried out while a relative humidity (RH) level of the indoor air is maintained at a comfortable condition for the occupants, such as within 0-90%, within 30-70%, or within 40-60%. In some embodiments, the method is carried out while the relative humidity (RH) level of the indoor air is maintained within 30%-70%. In some embodiments, the method is carried out while the relative humidity (RH) level of the indoor air is maintained within 40%-60%.

In some embodiments, the method is carried out while a total volatile organic compounds (TVOCs) level of the indoor air is maintained below 10 ppm, such as below 8 ppm, below 5 ppm, below 2 ppm, or below 1 ppm. In some embodiments, the method is carried out while a total volatile organic compounds (TVOCs) level of the indoor air is maintained below 1 ppm. To further improve the indoor air quality, additional agents (such as activated carbon) may be used in the present device or method to absorb or remove the undesired components in the indoor air (such as organic compounds). For example, the additional agent can be placed in a separate unit or container in the indoor environment. Alternatively, the additional agent can be placed in a compartment or unit of the present device to used together with the present carbon dioxide absorption composition. In some embodiments, the present method for improving indoor air quality further comprises passing the indoor air through activated carbon. In particular, the use of activated carbon can facilitate reducing the TVOCs levels in the indoor air. For example, by passing the indoor air through activated carbon, the present method can be carried out while maintaining the TVOCs further below 1 ppm, such as below 0.5 ppm, below 0.2 ppm, or below 0.1 ppm (100 ppb). In some embodiments, the present method includes passing the indoor air through activated carbon, and the TVOCs level of the indoor air is maintained below 0.1 ppm, such as below 50 ppb, below 20 ppb, or below 10 ppb.

A CO₂ desorption process may be utilized in the present methods to regenerate the CO₂ absorption composition. For example, the chemical reactions involved in the CO₂ desorption process include those illustrated in FIG. 1B. The CO₂ desorption process can be facilitated by the application of external energy, such as heating and microwave irradiation. As an example, the carbon dioxide-enriched composition may be heated (e.g., by a hot plate or heating unit) or subjected to microwave (e.g., an industrial or house-hold equipment). In some embodiments, the carbon dioxide-enriched composition may be more effectively regenerated by microwave irradiation as compared to heating. In some embodiments, the present methods for removing CO₂ or improving indoor air quality further comprises subjecting the carbon dioxide-enriched composition to microwave irradiation, thereby producing a regenerated carbon dioxide absorption composition and releasing the absorbed carbon dioxide.

In some embodiments, the method includes subjecting the carbon dioxide-enriched composition to microwave irradiation for about 10 to about 300 seconds, about 30 to about 270 seconds, about 50 to about 250 seconds, or about 60 to about 210 seconds. In some embodiment, a 1200-watt Panasonic microwave oven at heating power level 10 is utilized for irradiation, with an end temperature in the range about 90 to about 130° C. Typically, a 50 mL solution of the carbon dioxide-enriched composition is irradiated. Typically, the microwave irradiation process will release at least 70% of absorbed CO₂ from the composition.

The present methods can be operated in a continuous manner, by which the CO₂ adsorption-desorption processes are repeated in cycles. As used herein, each “cycle” or “regeneration cycle” refers to a complete sequence of CO₂ adsorption and desorption according to the present methods, resulting in a regenerated carbon dioxide absorption composition. In some embodiments, the present method further comprises reusing the regenerated carbon dioxide absorption composition for reaction with the carbon dioxide in the gas phase or indoor air. Typically, the regenerated composition retains most of its capacity of CO₂ absorption before regeneration. In some embodiments, the present composition can have less than 35% reduction in CO₂ absorption capacity after 10 regeneration cycles. In some embodiment, the initial 3-4 cycles may exhibit a relatively greater drop in capacity, which is stabilized in the later cycles. As a result, the variations in the last four cycles may be minimal. By recycling and reusing the regenerated carbon dioxide absorption composition, the method can be carried out in continuous cycles at reduced cost.

In some embodiment, the present method can include carrying out a plurality of carbon dioxide absorption-desorption cycles, each of which can include the steps of:
(A) contacting the gas phase or indoor air with the carbon dioxide absorption composition to produce a carbon dioxide-enriched composition and reduce the carbon dioxide content in the gas phase or indoor air;
(B) subjecting the carbon dioxide-enriched composition to microwave irradiation, thereby producing a regenerated carbon dioxide absorption composition and releasing the absorbed carbon dioxide; and
(C) recycling the regenerated carbon dioxide absorption composition to step (A) for reaction with the carbon dioxide in the gas phase or indoor air.

Typically, the desorption/regenerate process can be done with the release of CO₂ into an environment where the released CO₂ does not raise a safety concern. For example, the CO₂ absorbed from indoor air by the present composition or device can be released in an outdoor environment. In some embodiments, the desorption process is carried out in an outdoor environment. Alternatively, the absorbed CO₂ can be collected and used for production of other materials. For example, the CO₂ collected from the present method may be used in making mineral water or jet fuel. Thus, the present composition, device, and method offers an effective way to recycle CO₂, in particular CO₂ from indoor air, for a useful purpose. In some embodiments, the present method further comprises collecting the released carbon dioxide, such as in a storage container, for useful applications.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “have,” “has,” “having,” “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a,” “an,” and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. All references, including publications, patent applications, and patents, cited herein are hereby incorporated by reference.

The present invention has been described in terms of one or more embodiments, and it should be appreciated that all possible equivalents, alternatives, variations, and modifications, aside from those expressly stated are within the scope of the invention.

### EXAMPLES

This study explores the potential of various CO₂ capture solutions, including aqueous MEA, aqueous Arg, and water-glycol-Arg solutions, to enhance indoor air quality by regulating CO₂ levels, RH, and TVOC concentrations. Through experimental evaluations, the solutions' desorption capabilities, including regeneration efficiency, solvent stability, and visual integrity post-desorption, were analyzed using microwave irradiation at varying exposure times. A subsequent cyclic study was performed to assess the stability, safety, and long-term performance of aqueous MEA and water-PG-Arg solutions. This investigation advances our understanding of CO₂ capture kinetics and positions Arg as a promising, sustainable alternative to traditional absorbents like MEA.

### Example 1

### Materials and Methods

### Reagents

MEA (purity≥98%), L-arginine (purity≥98%), triethylene glycol (purity≥98%), dipropylene glycol (purity≥99%), diethylene glycol (purity≥99%), and ethylene glycol (purity≥99%) were procured from ThermoFisher Scientific. Propylene glycol (purity≥99.8%) was sourced from Millipore Sigma. All the solutions were prepared using Milli-Q water, and the CO₂ gas (purity≥99.999 mol %) was obtained from the Airgas company.

### Experimental Setup and Procedure

The CO₂ scrubbing solutions (CSS) were formulated by adding 0.05 mol of CSA to 50 mL of solvent. For the aqueous CSS, Milli-Q water was used as the solvent, while the water-glycol-based CSS was prepared by mixing water and glycol in a 1:1 volumetric ratio based on the solubility of Arg in water.

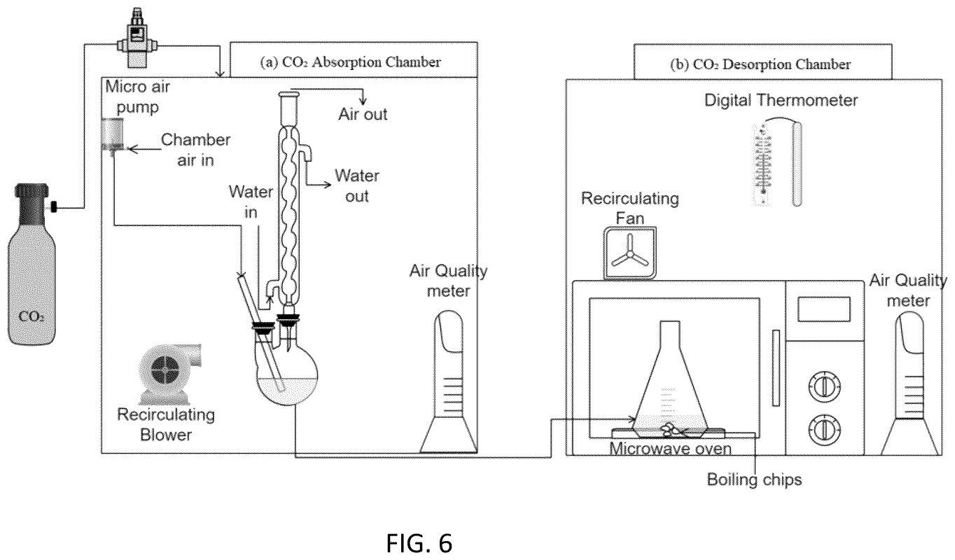

The CO₂ absorption setup consisted of a 100 mL two-neck round-bottom flask filled with the prepared CSS and connected to a condenser to minimize the loss of water and amine vapors. This setup was placed inside a sealed steel chamber measuring 32×33×36 inches (FIG. 6), equipped with a 12 V fan to ensure thorough mixing of air within. CO₂ was introduced from the top of the chamber until the concentration stabilized between 1000 and 1100 ppm.

The air inside was bubbled through the solution using a micro air pump during the CO₂ absorption process. The experiments were performed under laboratory conditions at atmospheric pressure, with an initial relative humidity of 54±5%. Changes in C_{CO}_{₂} (ppm), RH (%), and TVOCs (ppb) were continuously monitored using Graywolf IQ-610 sensors and logged at 30-second intervals with an advanced sense meter. As per the guidelines from Graywolf Sensing Solutions, the TVOC sensor operates accurately within a relative humidity (RH) range of 0 to 90%, becoming unreliable beyond this threshold. Consequently, in our study, TVOC data were recorded until the RH reached 90%. The VOCs generated inside the chamber were collected by passing the air through 20 mL of Milli-Q water for 60 minutes.

The resulting solution (referred to as the TVOC solution) was analyzed using Triple Quadrupole Liquid Chromatography-Mass Spectrometry (LC-QqQ-MS) and Headspace Solid-Phase Microextraction Gas Chromatography-Mass Spectrometry (HS-SPME-GC-MS). Specifically, Agilent Technologies 1260 infinity LC system coupled with Agilent Technologies 6460 Triple Quad LC/MS (LC-MS/MS) was used and molecules were ionized using an Electrospray Ionization (ESI) source. GC-MS analysis was conducted on an Agilent 7890B gas chromatograph coupled with an Agilent 5977B Mass Selective Detector, utilizing Electronic Impact (EI) for ionization and fragmentation. Mode for qualitative analysis of LC-QqQ-MS: MS2 scan (i.e., Full scan). Mode for quantitative analysis of LC-QqQ-MS: MRM scan (i.e., Multiple reaction monitoring)].

In some studies, the absorption setup included a charcoal canister. For all the absorption experiments, the charcoal canister was excluded to independently assess each solution's performance. It was integrated into the system only after optimizing and selecting the best solution.

Once the CO₂ absorption process was complete, water was added to replenish the solution that had evaporated due to vaporization. The solution was then transferred to a 500 mL conical flask, and a few small porcelain boiling chips were added to ensure smooth boiling and prevent bumping during the regeneration process. MW-assisted regeneration of the saturated scrubbing solution was performed. Initially, the temperature of the solution, along with the CCO₂, RH, and TVOC values, were recorded. The solution was then heated using a Panasonic 1200 W MW oven at heating power level 10 for varying time periods. The temperature and volume of the solution were recorded right after heating, whereas other parameters, such as TVOC and RH, were measured five minutes later after they had stabilized. Rather than using one prolonged MW heating duration, the desorption process was broken into shorter sessions to ensure that the solution did not dry out completely.

In an alternative desorption setup, conventional thermal heating was used. Once the solution was loaded with CO₂, water was added to replenish the volume lost due to vaporization. It was then transferred into a 100 ml three-neck round-bottom flask, with a condenser connected to the middle arm, a glass sparger on the left arm, and a thermometer on the right arm. First, the sand was preheated for 30 minutes by allowing it to stay on the hot plate at 2500 C. Then, the initial temperature of the sand and solution was noted, the two-neck round bottom flask was placed on it, and the chamber door was closed. Initial reading of CO₂, RH, and TVOC was also recorded, and the micropump was turned on. This desorption experiment was continued until the CO₂ concentration curves plateaued over a period of time. At this point, the final reading of the above-mentioned parameters was recorded, and the chamber was opened to note the final temperatures of the solution and the sand bath, thereby concluding the desorption process.

Energy consumption during the desorption process was measured using a P3 Kill-A-Watt meter, connected between the main power supply and the hot plate and microwave. For the micro air pump, energy use was calculated based on the voltage and current from the DC power supply, and the operation duration. The total energy consumed by each equipment was documented.

### Quantitative Analysis and Kinetics

The CO₂ loading (α_{abs}) is defined as the moles of CO₂ absorbed per unit moles of CSA, while the CO₂ unloading (α_{des}) represents the reverse process (Song et al., 2012). These values were calculated using the following formula based on the initial and final CO₂ concentrations.

$${CO}_{2} loading / removed ( α ) = \frac{Moles of {CO}_{2} absorbed / desorbed}{Moles of {CO}_{2} scrubbing agent} ( mol )$$

$$Moles of {CO}_{2} Abs . / Des . ( {n}_{{co}_{2}} ) = \frac{Δ C}{1000000} \times \frac{1}{{M}_{{CO}_{2}}} \times {ρ}_{C {O}_{2}} \times 1000 \times {V}_{c} ( mol )$$

$$ΔC = Initial Conc . of {CO}_{2} ( ppm ) - Final Conc . of {CO}_{2} ( ppm )$$

$$Moles of {CO}_{2} scrubbing agent = \frac{Mass}{Molecular weight} ( mol )$$

Where ΔC is the concentration gradient, M_{CO}_{₂}=44 g/mol and pco2=1.96×10⁻³ g/ml are the molecular weight and density of CO₂, respectively, and V_{c}=623 liter is the chamber volume. The amount of CO₂ absorbed or desorbed (in mg) depends on the moles of CO₂ absorbed or desorbed (n_{CO}_{₂}) and can be calculated using the following formula:

$$Amount of {CO}_{2} abs . / des . = {n}_{C {O}_{2}} \times {M}_{C {O}_{2}} \times 1000 ( mg )$$

Additionally, based on the CO₂ absorption experimental data, the integrated rate law equation for a second-order reaction was used to model the kinetics of gas-liquid absorption reactions. The reaction rate constant (K″) was determined from the slope of the linear regression plot of 1/C_{CO}_{₂} versus time.

### Results and Discussion

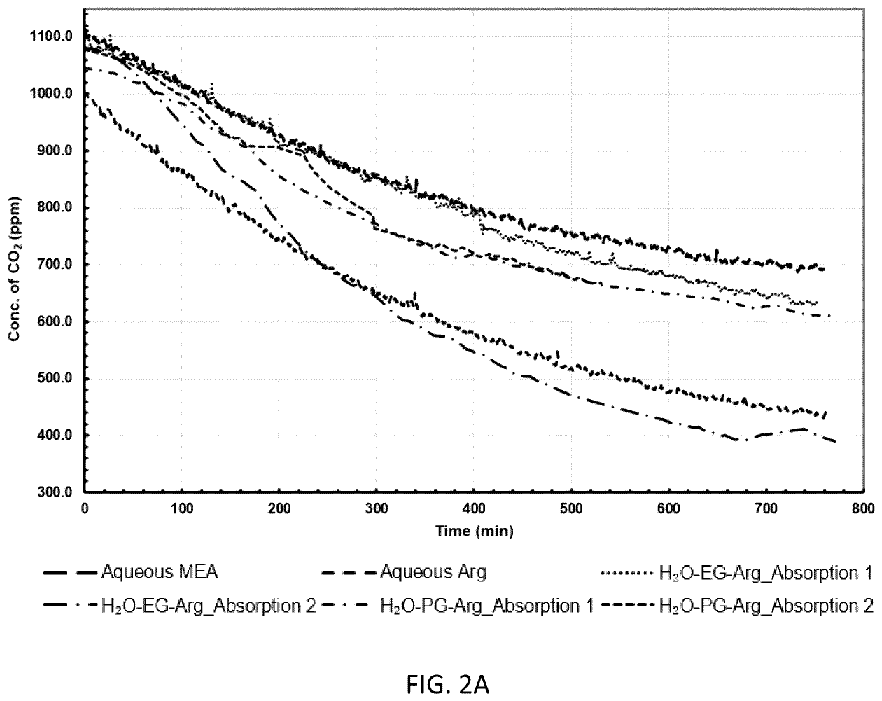

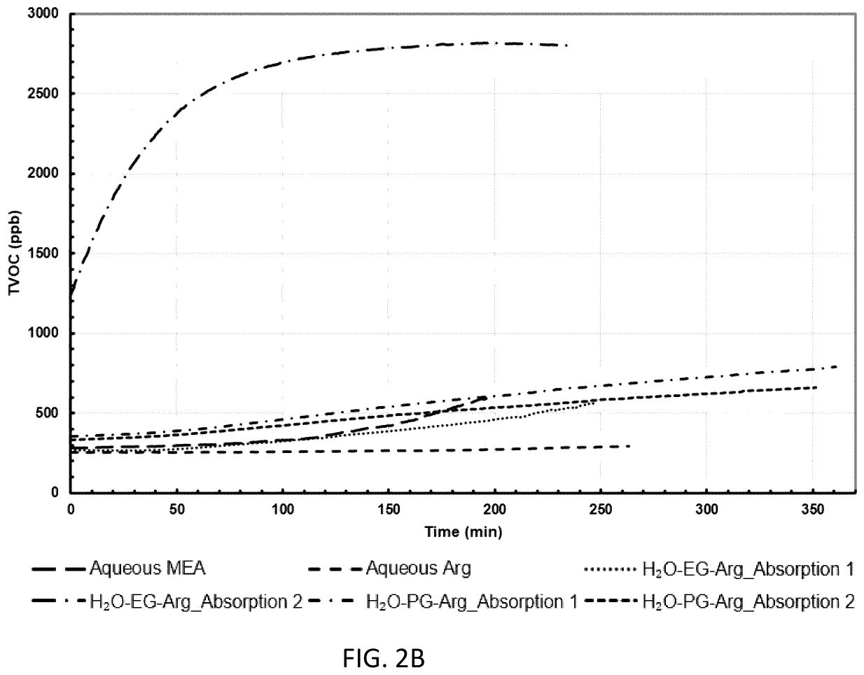

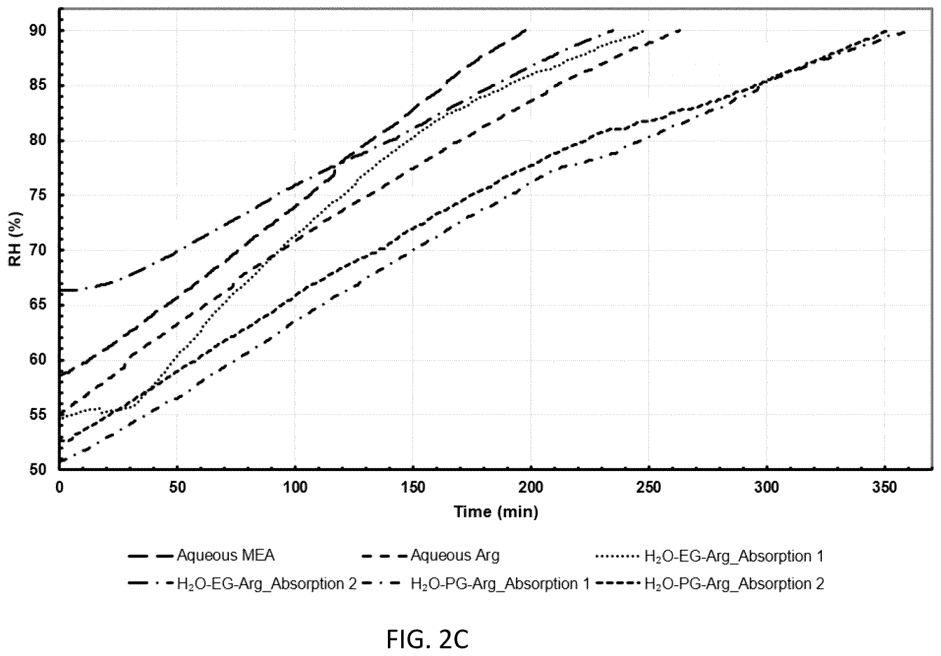

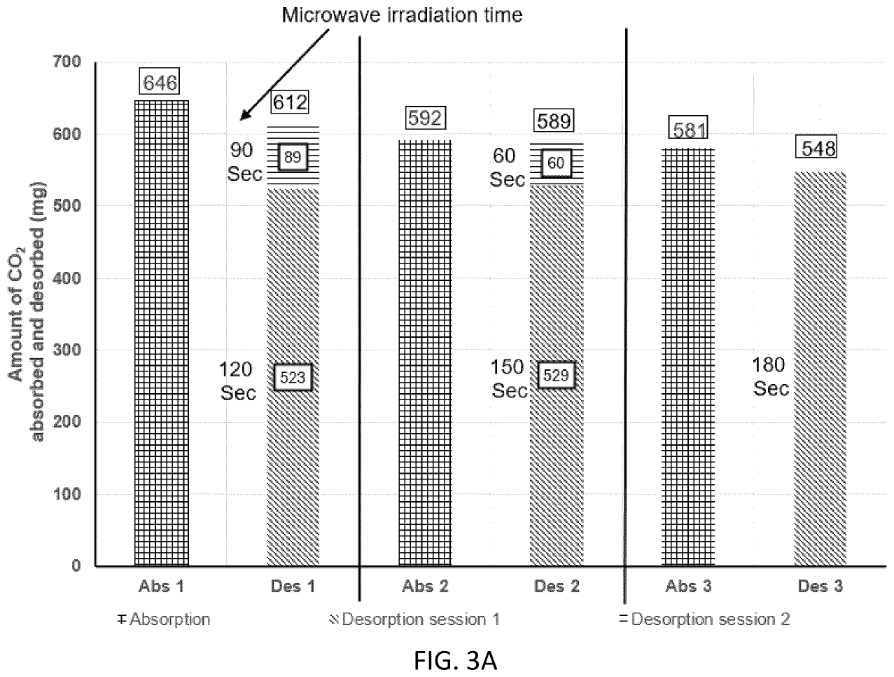

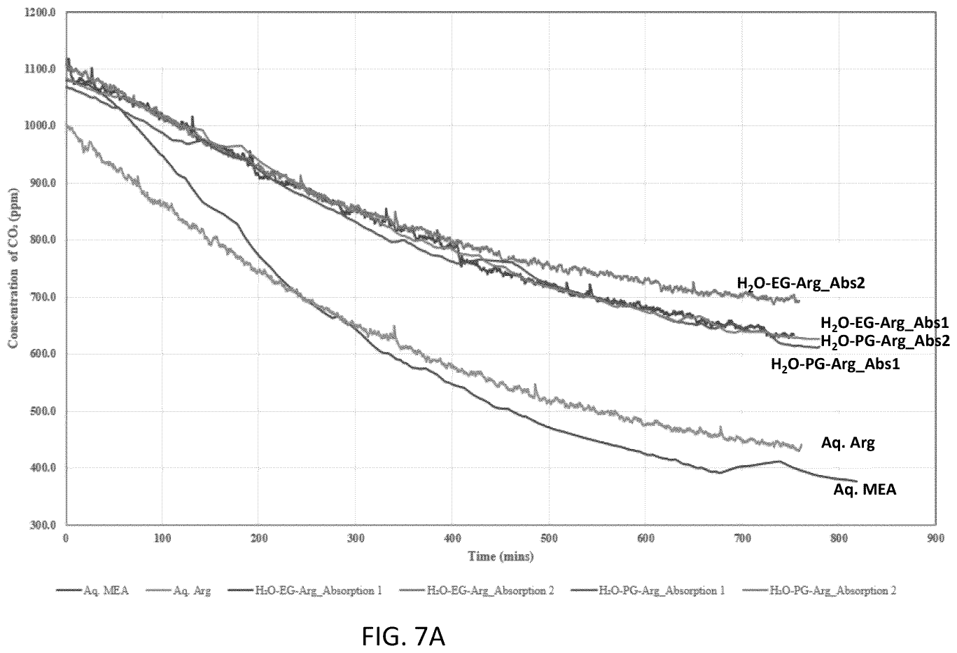

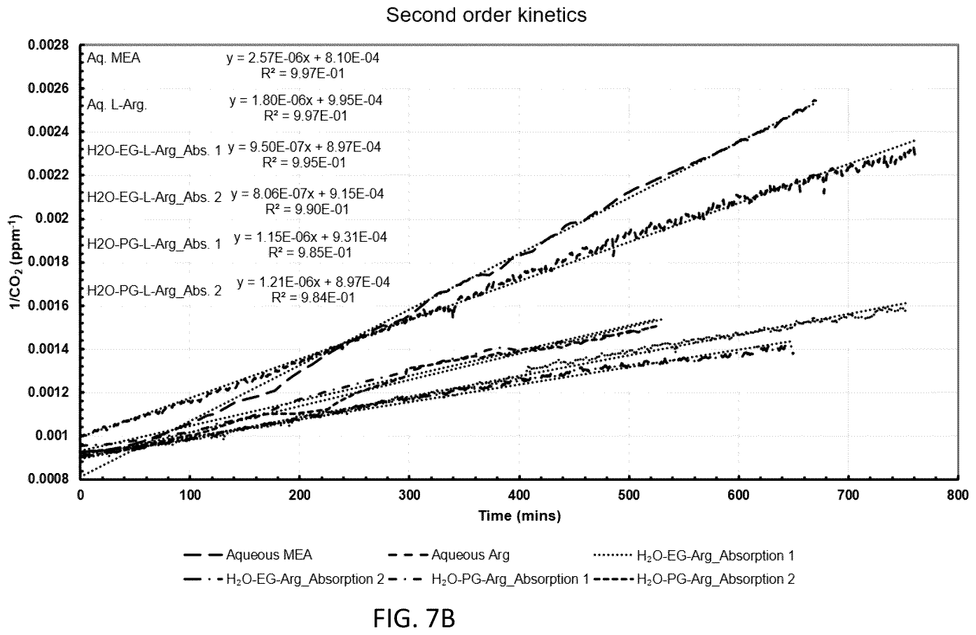

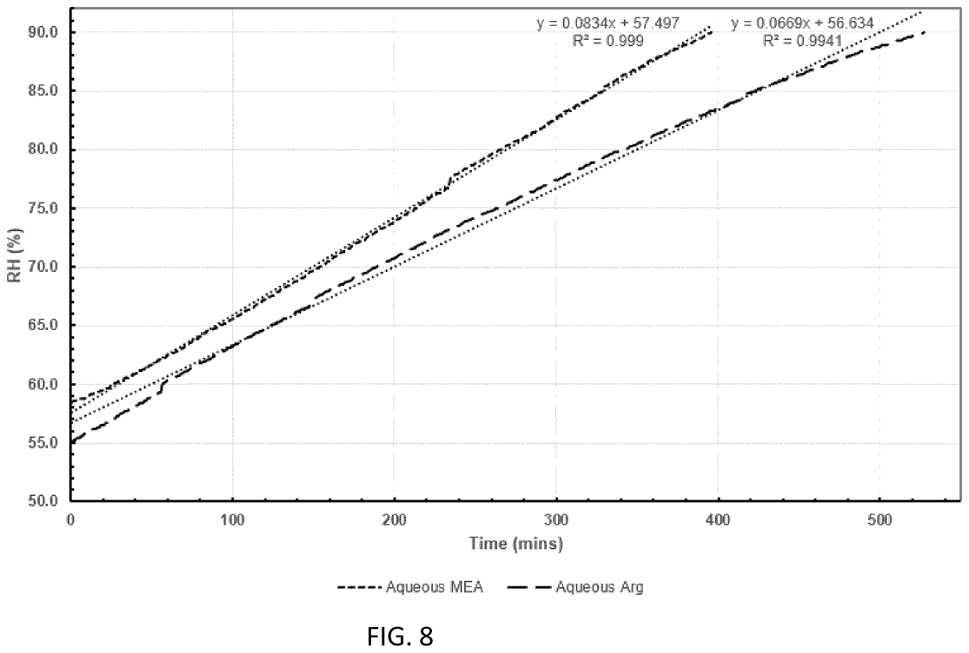

The performances of aqueous MEA and aqueous Arg solutions in terms of CO₂ absorption, kinetics, and their impact on RH levels and TVOC concentrations were evaluated. Although the aqueous Arg solution showed a lower capacity for CO₂ absorption (α=0.31 mol/mol) and slower kinetics (K″=1.80×10⁻⁶ ppm⁻¹ min⁻¹) compared to the aqueous MEA solution (α=0.40 mol/mol and K″=2.57×10⁻⁶ ppm⁻¹ min⁻¹) (FIG. 2A and FIG. 7B), presumably due to Arg's larger molecular size (Suleman et al., 2020) affecting solution viscosity and hindering CO₂ diffusion, it still presents notable advantages over MEA, particularly concerning VOC emissions and RH behavior. The aqueous MEA solution caused a significant increase in TVOC levels during the absorption process, as shown in FIG. 2B, whereas the aqueous Arg solution produced minimal to no detectable rise in TVOCs. Qualitative analysis of the VOCs emitted from the aqueous MEA solution using LC-QqQ-MS identified MEA as the primary volatile component, as its higher vapor pressure likely contributed to elevated TVOC levels, highlighting a potential drawback of using MEA for CO₂ absorption. In contrast, the aqueous Arg solution demonstrated lower vapor pressure, as evidenced by the RH profiles. Analysis of the RH slopes revealed that the Arg solution took longer to reach 90% RH compared to the MEA solution, indicating a lower vaporization rate (FIG. 8). These findings indicate that, while the aqueous Arg solution has slightly lower CO₂ absorption capacity and slower kinetics, it is a more environmentally sustainable option due to its minimal VOC emissions, especially indoors. To further evaluate the practical application of these solutions, MW regeneration experiments were conducted to assess their sustainability for continuous absorption-desorption cycles.

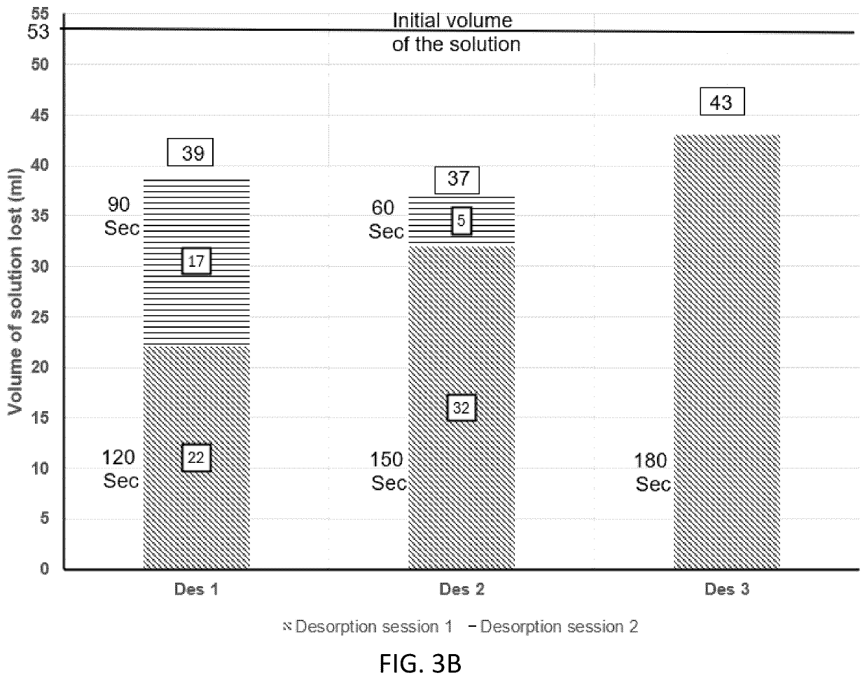

Microwave heating was employed for CO₂ desorption due to its faster process, lower energy consumption, and simpler setup compared to conventional heating. The irradiation process was optimized to achieve full solution regeneration with minimal microwave irradiation time and solvent loss; to this end, a series of absorption-desorption studies were conducted using aqueous MEA solutions. The first MW irradiation time was adjusted by careful inspection of the solution during the MW session to avoid excessive boiling and bumping of the solution inside the MW chamber, while achieving maximum CO₂ desorption possible. As shown in FIGS. 3A and 3B, it was observed that increasing the first MW session beyond 150 secs led to excessive solvent loss and worse CO₂ desorption outcome. The optimum MW irradiation profile was found to be an initial MW session of 150 secs followed by another session of 60 seconds, achieving near-complete regeneration by desorbing 589 mg (99.5%) of CO₂ from 592 mg absorbed, while limiting solvent loss to just 37 ml.

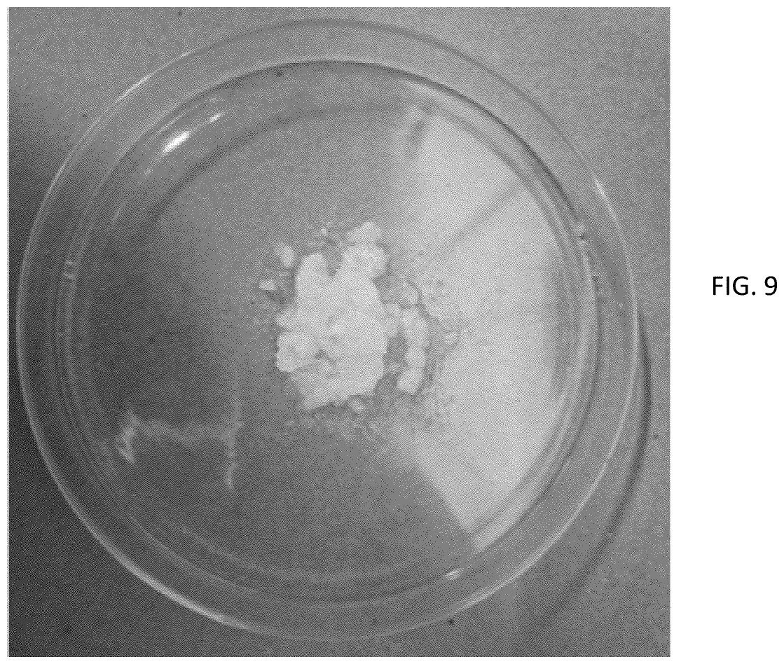

While the optimal MW irradiation times of 150 sec for the first session and 60 sec for the second session were effective for aqueous MEA, they proved insufficient for aqueous Arg solution. Only 436 mg (63.5%) of CO₂ was desorbed from the 687 mg absorbed in the first session. Extending the second session to 90 seconds released an additional 82 mg, totaling 518 mg (75.4%), showing that the desorption remained incomplete. Prolonged MW irradiation also caused complete solvent evaporation, leaving behind solid Arg crystals, as shown in FIG. 9. To address this issue and maintain the solution in liquid form, a water-glycol-based Arg solution was formulated.

The choice of glycol with a higher boiling point was intended to manage the RH during the absorption process in view of its hygroscopic properties and to reduce complete evaporation of the solution during the desorption process. To formulate the water-glycol-based CSS, water and glycol were mixed in an optimized 1:1 volumetric ratio. A comprehensive evaluation of some commonly used glycol compounds was conducted, focusing on key properties such as low vapor pressure, appropriate viscosity, and high molecular weight, as shown in Table 2. Among these, the water-EG-Arg and water-PG-Arg solutions exhibited better Arg solubility and were thus chosen for further studies. Although pure glycol-Arg solutions were initially explored, they exhibited poor solubility of Arg in glycol and resulted in high viscosity of the solution, which hindered CO₂ diffusion. Consequently, water was incorporated to enhance both the absorption performance and kinetics of the solution.

As illustrated in FIGS. 7A and 7B, the presence of glycol in the solution slowed the diffusion of CO₂ from the gas to the liquid phase, reducing both the amount of CO₂ absorbed and its reaction kinetics.

While the water-PG-Arg solution initially showed slightly lower CO₂ absorption capacity (α=0.24 mol/mol, K″=1.15×10⁻⁶ ppm⁻¹ min⁻¹) than the water-EG-Arg solution (α=0.26 mol/mol, K″=0.95×10⁻⁶ ppm⁻¹ min⁻¹) (Table 1), it exhibited comparable kinetics and offered better RH control, taking longer to reach 90% RH during absorption (FIGS. 2A-2C). Qualitative analysis using LC-QqQ-MS and HS-SPME-GC-MS identified only propylene glycol among the emitted VOCs, with no trace of Arg in the case of water-PG-Arg solution. It is worth mentioning that PG, as a VOC, is odorless, non-toxic, and has a Workplace Environmental Exposure Limit (WEEL) of 3200 ppb, averaged over an 8-hour work shift, as set by the American Industrial Hygiene Association (AIHA) (New Jersey Department of Health, 2009). This limit is at least five times higher than the levels detected in our experiment. During desorption, the water-PG-Arg solution achieved ˜90% regeneration in a shorter time, reducing energy consumption by 29% (Table 3). Additionally, no visible color change was observed in the water-PG-Arg solution after the first desorption process, whereas the water-EG-Arg solution exhibited a shift from transparent to amber, indicating possible degradation.

TABLE 1
CO₂ absorption and reaction kinetics of aqueous MEA and aqueous Arg
solutions. Rate Constant (K″) is based on second-order kinetics.

| | | Rate | | Initial | Final |
|---|---|---|---|---|---|
| | Amt. of | constant | CO₂ abs. | TVOC at | TVOC at |
| | CO₂ abs. | K″ × 10⁻⁶ | time | RH 54 ± 5% | RH 90% |
| Solution | (mg) | (ppm⁻¹min⁻¹) | (min) | (ppb) | (ppb) |
| H₂O (50 ml) + MEA (3 g) | 860 | 2.57 | 819 | 285 | 601 |
| H₂O (50 ml) + Arg (8.71 g) | 687 | 1.80 | 752 | 255 | 293 |
| H₂O (25 ml) + EG (25 ml) + | 582 | 0.95 | 754 | 269 | 562 |
| Arg (8.71 g) | | | | | |
| H₂O (25 ml) + PG (25 ml) + | 531 | 1.15 | 771 | 358 | 789 |
| Arg (8.71 g) | | | | | |

TABLE 2
Summary table of properties of glycols solvents.

| | | | | Dynamic |
|---|---|---|---|---|
| | Boiling point | Molecular | Vapor pressure | viscosity |
| Organic | (° C. at | weight | (mmHg at | (cP at |
| solvent | 1 atm) | (g/mol) | 20° C.) | 20° C.) |
| Ethylene | 196-198 | 62.06 | 0.12 | 21 |
| Glycol (EG) | | | | |
| Diethylene | 245 | 106.12 | 0.01 | 37.2 |
| glycol (DEG) | | | | |
| Tri ethylene | 285 | 150.17 | <0.0075 | 48 |
| glycol (TEG) | | | | |
| Propylene | 187 | 76.1 | 0.097 | 45 |
| glycol (PG) | | | | |
| Di-propylene | 180-190 | 148.2 | <0.01 | 4.32 |
| glycol (DPG) | | | | |

TABLE 3
Two absorption-desorption cycle comparisons
between H₂O-EG-Arg and H₂O-PG-Arg solutions.

| | | | Amount | | Energy |
|---|---|---|---|---|---|
| | | | of CO₂ | Run time | consumed |
| Solutions | Cycles | Process | (mg) | (min) | (Whr) |
| H₂O (25 ml) + | 1 | Abs. 1 | 582 | 754 | 17.1 |
| EG (25 ml) + | | Des. 1 | 591 | 5 | 140 |
| Arg (8.71 g) | 2 | Abs. 2 | 521 | 759 | 17.3 |
| | | Des. 2 | 556 | 4.5 | 130 |
| H₂O (25 ml) + | 1 | Abs. 1 | 531 | 771 | 17.6 |
| PG (25 ml) + | | Des. 1 | 481 | 3.5 | 100 |
| Arg (8.71 g) | 2 | Abs. 2 | 499 | 530 | 12.1 |
| | | Des. 2 | 463 | 3.5 | 100 |

In subsequent cyclic test, the water-PG-Arg solution demonstrated improved stability with consistently lower TVOC emissions during absorption (FIG. 2B) and no color change after desorption processes. The water-EG-Arg solution, however, emitted notably higher TVOCs with an unpleasant pungent odor throughout the cyclic study, and its color gradually deepened to a darker red after each desorption process. This degradation was likely driven by elevated temperatures during desorption processes, reaching 156° C. in the first cycle and 176° C. in the second, suggesting potential side reactions and thermal degradation (Tables 5 and 6). In contrast, the water-PG-Arg solution exhibited lower temperature increases during desorption (Tables 7 and 16), attributed to the higher specific heat capacity of PG (Table 4). Additionally, PG's lower polarity and dielectric constant limited the absorption of MW energy, reducing excessive heat generation. Thus, the thermal stability, improved absorption performance, and reduced energy consumption of the water-PG-Arg solution highlight its potential for long-term CO₂ capture applications. These findings support further investigation into its cyclic performance over multiple absorption-desorption processes.

TABLE 4
Dielectric properties and heat capacity
of Ethylene glycol and propylene glycol.

| | Dielectric | Dielectric | Specific heat capacity |
|---|---|---|---|
| | constants | loss factor | [cp] |
| Compound | [ε′] | [ε″] | (J/mol ° C. at 25° C.) |
| Ethylene | 41.2 | 5 | 149.8 |
| Glycol | | | |
| Propylene | 30.2 | 1 | 189.9 |
| Glycol | | | |

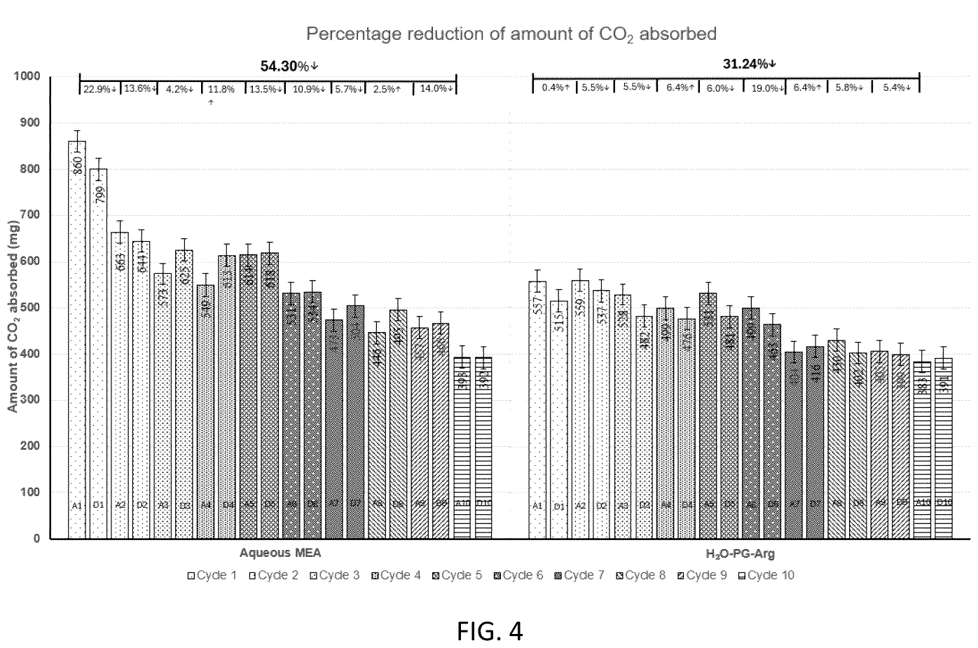

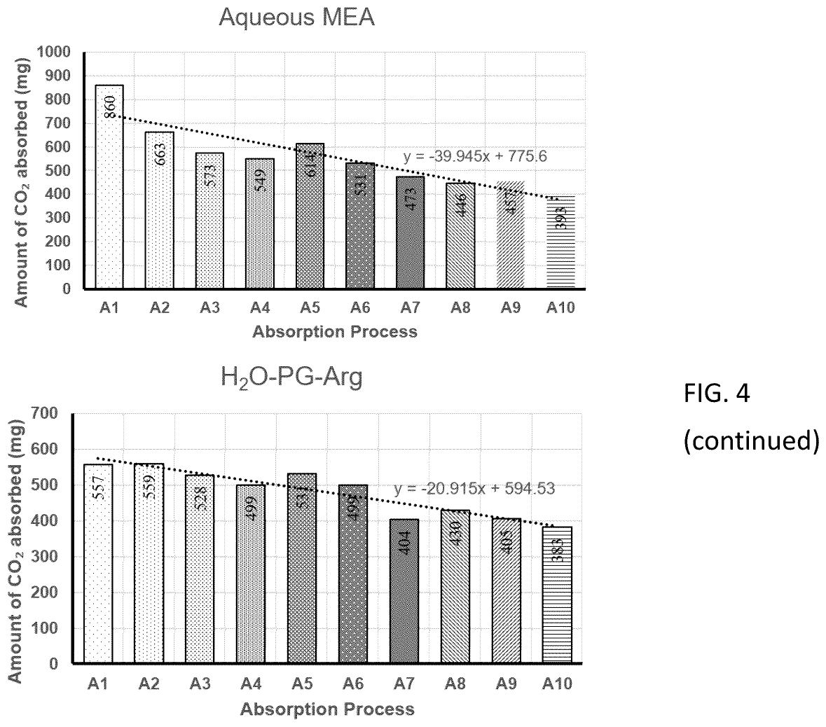

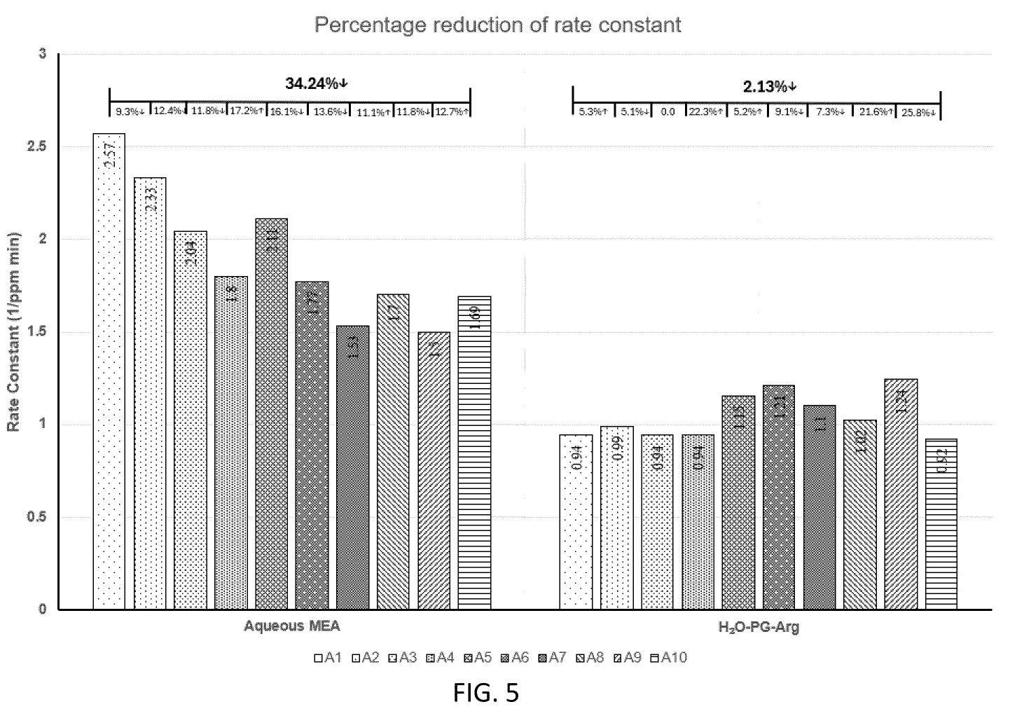

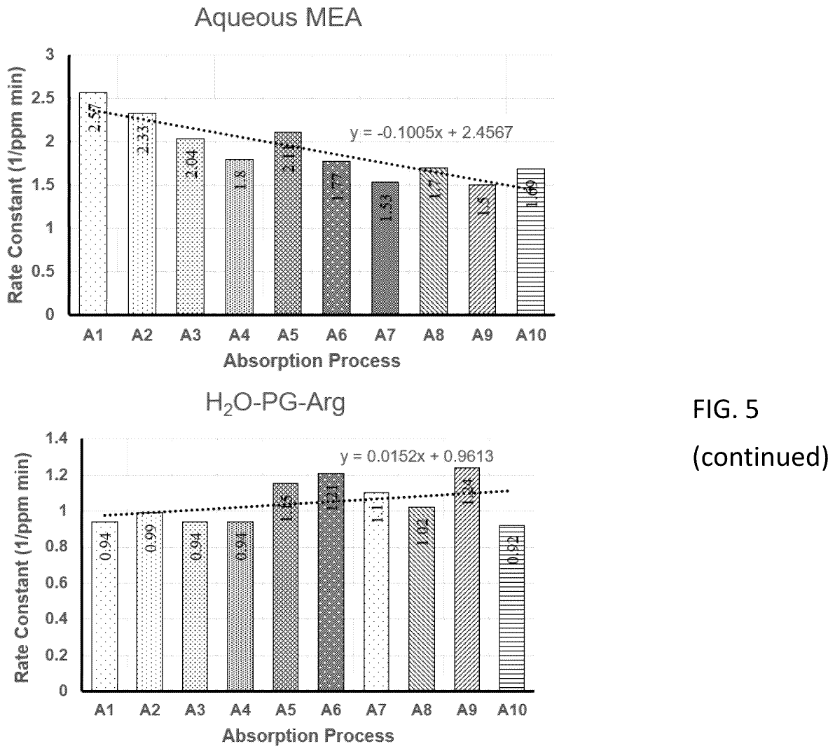

The cyclic performances of aqueous MEA and water-PG-Arg solutions were evaluated over ten absorption-desorption cycles, as shown in FIG. 4, panels (a) and (b). The reaction rate constants for both solutions across these cycles are presented in FIG. 5, panels (a) and (b). Although the aqueous MEA solution initially exhibited higher CO₂ absorption, its performance declined significantly over time, with a 54.3% reduction in CO₂ absorption after ten cycles. In contrast, the water-PG-Arg solution demonstrated greater stability, with only a 31.24% decline over the same period, becoming increasingly more consistent as our study progressed. The steeper downward trend observed in the MEA solution (FIG. 4, panel (b)) highlights its limitations for long-term CO₂ capture applications. Notably, during the third cycle of the aqueous MEA solution, 625 mg of CO₂ was desorbed, exceeding the 573 mg absorbed, attributed to experimental error or due to residual CO₂ from previous cycles. This behaviour was observed several times throughout the study. The effectiveness of the aqueous MEA solution declines over time because of oxidative and thermal degradation, leading to a reduced concentration of MEA available for CO₂ absorption. The degradation products, such as ammonia, acetaldehyde, and acetone, may pose potential risks to indoor environments. As a result, the reaction rate constant of the aqueous MEA solution decreased by 34.24% after ten cycles, compared to only a 2.13% reduction for the water-PG-Arg solution. These findings highlight the superior stability and long-term viability of the water-PG-Arg solution for indoor CO₂ capture applications.

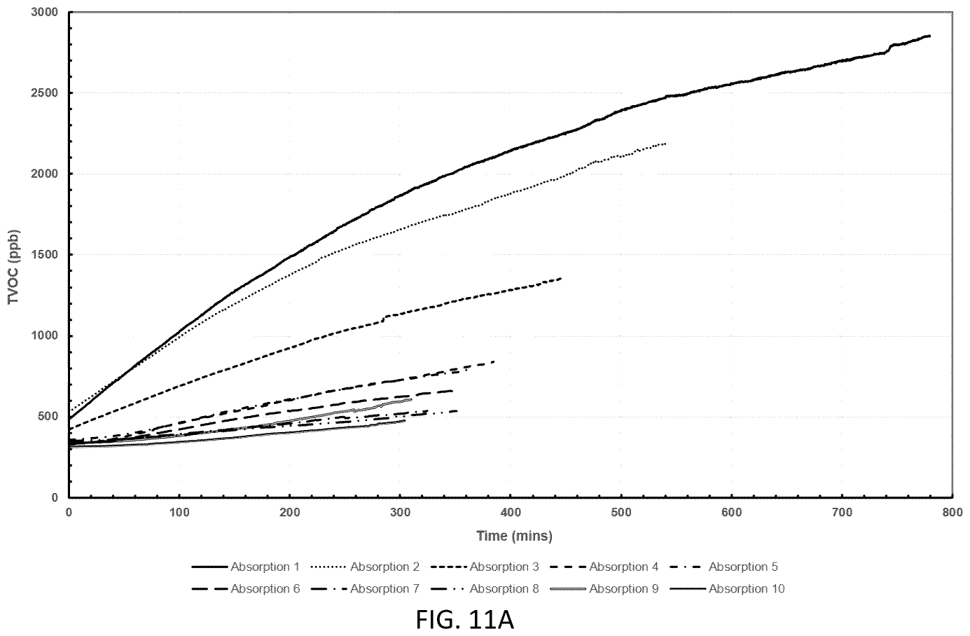

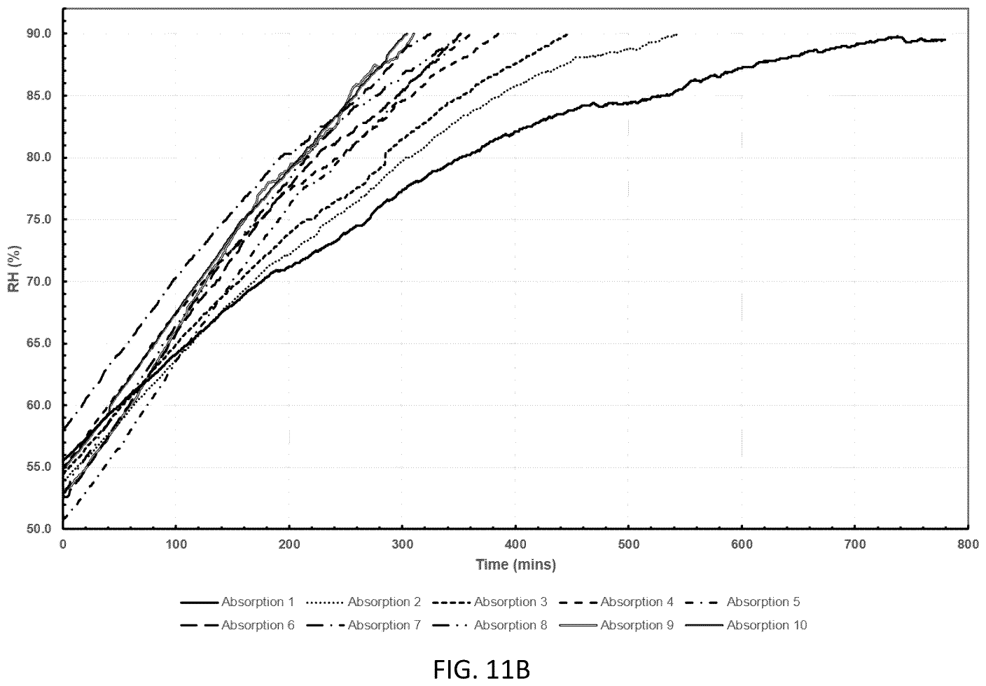

FIGS. 11A-11B illustrates the RH levels and TVOC concentrations during 10 absorption cycles of the H₂O-PG-Arg solution. Initially, the solution took longer to reach a RH of approximately 90% in the chamber; however, its ability to maintain RH progressively declined as the solution was used repeatedly. In contrast, TVOC concentrations were highest during the first cycle and they kept decreasing with each subsequent cycle. To understand this, TVOCs were sampled to analyze the compounds via LC-MS-QqQ and HS-SPME-GC-MS after the initial absorption process.

The analysis confirmed the presence of PG with no trace of Arg, based on the mass spectral data of water-PG-Arg solution and blank, which look similar. This analysis highlights Arg's stability across multiple cycles. However, the solution's declining ability to control RH during absorption can be attributed to PG evaporation during desorption, leading to a reduced mole fraction of PG in the resulting solutions, which can be attributed to a gradually lower TVOC generation.

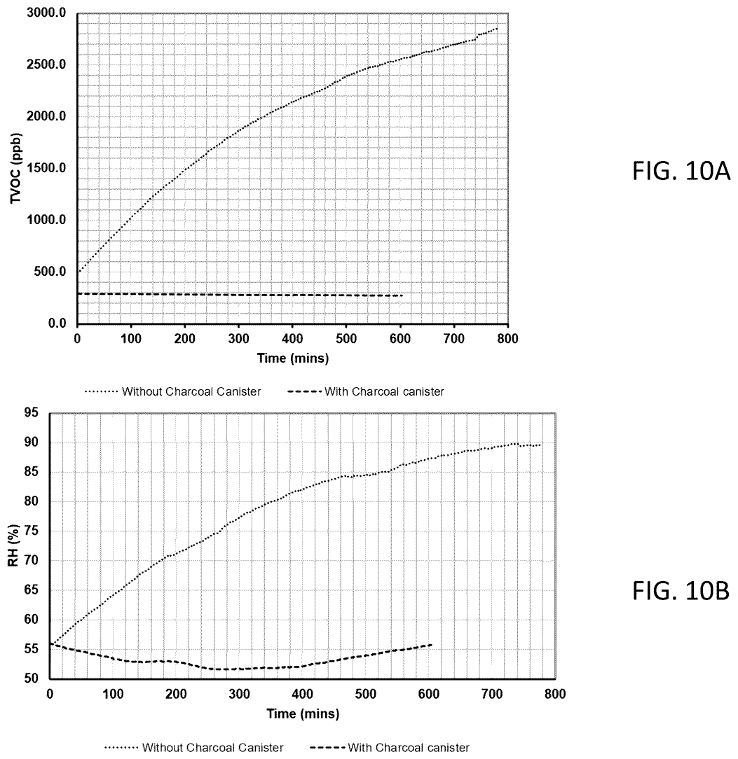

To further enhance indoor air quality by capturing VOCs during absorption, a charcoal canister was integrated into the setup. FIGS. 10A-10B illustrate the system's performance with and without the charcoal canister.

As anticipated, the results indicate that activated charcoal effectively reduced TVOC level throughout the experiment while adsorbing some water vapor, stabilizing RH. It is worth mentioning that PG, as a VOC, is odourless, non-toxic, and has a Workplace Environmental Exposure Limit (WEEL) of 3200 ppb, averaged over an 8-hour work shift, as set by the American Industrial Hygiene Association (AIHA). This limit is at least twelve times higher than the levels recorded in our experiment (i.e., 271 ppb). This stability of VOCs within the chamber highlights the charcoal canister's efficacy in limiting PG escape into the air, further supporting the reliability of the water-PG-Arg solution in capturing CO₂.

Tables 5-6 show experimental data of 2 absorption-desorption cycles of H₂O-EG-Arg solution. Tables 7-16 show experimental data of 10 absorption-desorption cycles of H₂O-PG-Arg solution. Tables 17-27 show experimental data of absorption-desorption cycles of the aqueous MEA solution.

TABLE 5
Experimental data of first absorption-desorption cycle of aqueous H₂O-EG-Arg solution.
Cycle 1

| | Concentration | | | Solution | |
|---|---|---|---|---|---|
| Absorption 1 | of CO₂ (ppm) | RH (%) | TVOC (ppb) | volume (ml) | pH |
| Initial | 1110 | 55 | 269 | 53 | 10 |
| Final | 633 | 100 | 12011 | 48 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 477 | 582 | 0.26 | 0.95 | 5 | 754 |

Desorption 1

| Desorption step 1 | Microwave desorption time - 60 sec | | | | |
|---|---|---|---|---|---|
| HPL - 10 | Initial | After | 5 min wait | Final | Difference |
| | | desorption | for air to mix | | |
| Conc. of CO₂ (ppm) | 387 | — | properly in | 600 | 213 |
| Volume of solution (ml) | 53 | 48 | the chamber | — | 5 |
| Temperature (° C.) | 22.7 | 103 | | 54.8 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 600 | — | properly in | 688 | 88 |
| Volume of solution (ml) | 48 | 40 | the chamber | — | 8 |
| Temperature (° C.) | 54.8 | 110 | | 58.9 | — |
| Desorption step 3 | Microwave desorption time - 60 sec | | | | |
| HPL - 10 | Initial | After | 5 min wait | Final | Difference |
| | | desorption | for air to mix | | |
| Conc. of CO₂ (ppm) | 688 | — | properly in | 763 | 75 |
| Volume of solution (ml) | 40 | 32 | the chamber | — | 8 |
| Temperature (° C.) | 58.9 | 118.9 | | 60.7 | — |
| Desorption step 4 | Microwave desorption time - 60 sec | | | | |
| HPL - 10 | Initial | After | 5 min wait | Final | Difference |
| | | desorption | for air to mix | | |
| Conc. of CO₂ (ppm) | 763 | — | properly in | 830 | 67 |
| Volume of solution (ml) | 32 | 27 | the chamber | — | 5 |
| Temperature (° C.) | 60.7 | 133.9 | | 62 | — |
| Desorption step 5 | Microwave desorption time - 60 sec | | | | |
| HPL - 10 | Initial | After | 5 min wait | Final | Difference |
| | | desorption | for air to mix | | |
| Conc. of CO₂ (ppm) | 830 | — | properly in | 895 | 41 |
| Volume of solution (ml) | 27 | 23 | the chamber | — | 4 |
| Temperature (° C.) | 62 | 156 | | 80.2 | — |
| Concentration of CO₂ | 484 | Amount of | 591 | Volume of the | 30 |
| desorbed (ppm) | | CO₂ desorbed | | solution lost | |
| | | (mg) | | (ml) | |
| Energy consumed | 140 | CO₂ unloading (mole | | 0.27 | |
| during Desorption | | CO₂/mole L-arg) | | | |
| (Wh) | | | | | |

TABLE 6
Experimental data of second absorption-desorption cycle of aqueous H₂O-EG-Arg solution.
Cycle 2

| | Concentration | | | Solution | |
|---|---|---|---|---|---|
| Absorption 1 | of CO₂ (ppm) | RH (%) | TVOC (ppb) | volume (ml) | pH |
| Initial | 1118 | 66.4 | 1234 | 53 | 10 |
| Final | 691 | 100 | 3736 | 47 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 427 | 521 | 0.24 | 0.75 | 6 | 759 |

Desorption 1

| Desorption step 1 | Microwave desorption time - 90 sec | | | | |
|---|---|---|---|---|---|
| HPL - 10 | Initial | After | 5 min wait | Final | Difference |
| | | desorption | for air to mix | | |
| Conc. of CO₂ (ppm) | 379 | — | properly in | 615 | 236 |
| Volume of solution (ml) | 53 | 38 | the chamber | — | 15 |
| Temperature (° C.) | 23 | 106.7 | | 55 | — |
| Desorption step 2 | Microwave desorption time - 90 sec | | | | |
| HPL - 10 | Initial | After | 5 min wait | Final | Difference |
| | | desorption | for air to mix | | |
| Conc. of CO₂ (ppm) | 615 | — | properly in | 717 | 102 |
| Volume of solution (ml) | 38 | 27 | the chamber | — | 11 |
| Temperature (° C.) | 55 | 111.8 | | 65.1 | — |
| Desorption step 3 | Microwave desorption time - 90 sec | | | | |
| HPL - 10 | Initial | After | 5 min wait | Final | Difference |
| | | desorption | for air to mix | | |
| Conc. of CO₂ (ppm) | 717 | — | properly in | 834 | 117 |
| Volume of solution (ml) | 27 | 16 | the chamber | — | 11 |
| Temperature (° C.) | 56.1 | 176 | | 68.3 | — |
| Concentration of | 455 | Amount of | 556 | Volume of the | 37 |
| CO₂ desorbed | | CO₂ desorbed | | solution lost | |
| (ppm) | | (mg) | | (ml) | |
| Energy consumed | 130 | CO₂ unloading (mole | | 0.25 | |
| during Desorption | | CO₂/mole L-arg) | | | |
| (Wh) | | | | | |

TABLE 7
Experimental data of first absorption-desorption cycle of H₂O-PG-Arg solution.
Cycle 1

| | Concentration | | | Solution | |
|---|---|---|---|---|---|
| Absorption 1 | of CO₂ (ppm) | RH (%) | TVOC (ppb) | volume (ml) | pH |
| Initial | 1068 | 55.5 | 484 | 55 | 10 |
| Final | 612 | 89.5 | 2850 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 456 | 557 | 0.25 | 0.94 | 6 | 780 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 376 | — | properly in | 798 | 422 |
| Volume of solution (ml) | 55 | 25 | the chamber | — | 30 |
| Temperature (° C.) | 13 | 135.5 | | 55 | — |
| Concentration of | 422 | Amount of | 515 | Volume of the | 30 |
| CO₂ desorbed (ppm) | | CO₂ desorbed | | solution lost | |
| | | (mg) | | (ml) | |
| Energy consumed | 70 | CO₂ unloading (mole | | 0.23 | |
| during Desorption | | CO₂/mole L-arg) | | | |
| (Wh) | | | | | |

TABLE 8
Experimental data of second absorption-desorption cycle of H₂O-PG-Arg solution.
Cycle 2

| | Concentration | | | Solution | |
|---|---|---|---|---|---|
| Absorption 1 | of CO₂ (ppm) | RH (%) | TVOC (ppb) | volume (ml) | pH |
| Initial | 1083 | 53.7 | 530 | 55 | 10 |
| Final | 625 | 94.2 | 2715 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 458 | 559 | 0.25 | 0.99 | 6 | 781 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 387 | — | properly in | 787 | 400 |
| Volume of solution (ml) | 55 | 26 | the chamber | — | 29 |
| Temperature (° C.) | 22.7 | 104.5 | | 53 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 787 | — | properly in | 827 | 40 |
| Volume of solution (ml) | 26 | 21 | the chamber | — | 5 |
| Temperature (° C.) | 53 | 123.8 | | 51.3 | — |
| Concentration of | 440 | Amount of | 537 | Volume of the | 34 |
| CO₂ desorbed (ppm) | | CO₂ desorbed | | solution lost | |
| | | (mg) | | (ml) | |
| Energy consumed | 100 | CO₂ unloading (mole | | 0.24 | |
| during Desorption | | CO₂/mole L-arg) | | | |
| (Wh) | | | | | |

TABLE 9
Experimental data of third absorption-desorption cycle of H₂O-PG-Arg solution.
Cycle 3

| | Concentration | | | Solution | |
|---|---|---|---|---|---|
| Absorption 1 | of CO₂ (ppm) | RH (%) | TVOC (ppb) | volume (ml) | pH |
| Initial | 1066 | 54.5 | 421 | 55 | 10 |
| Final | 634 | 97.1 | 1873 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 432 | 528 | 0.24 | 0.93 | 6 | 773 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 390 | — | properly in | 761 | 371 |
| Volume of solution (ml) | 55 | 28 | the chamber | — | 27 |
| Temperature (° C.) | 22.8 | 101.1 | | 55.4 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 761 | — | properly in | 785 | 24 |
| Volume of solution (ml) | 28 | 21 | the chamber | — | 7 |
| Temperature (° C.) | 55.4 | 107.3 | | 52.1 | — |
| Concentration of | 395 | Amount of | 482 | Volume of the | 34 |
| CO₂ desorbed | | CO₂ desorbed | | solution lost | |
| (PPM) | | (mg) | | (ml) | |
| Energy consumed | 100 | CO₂ unloading (mole | | 0.22 | |
| during Desorption | | CO₂/mole L-arg) | | | |
| (Wh) | | | | | |

TABLE 10
Experimental data of fourth absorption-desorption cycle of H₂O-PG-Arg solution.
Cycle 4

| | Concentration | | | Solution | |
|---|---|---|---|---|---|
| Absorption 1 | of CO₂ (ppm) | RH (%) | TVOC (ppb) | volume (ml) | pH |
| Initial | 1089 | 54.9 | 330 | 55 | 10 |
| Final | 680 | 98.5 | 1398 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 409 | 499 | 0.23 | 0.94 | 6 | 682 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 370 | — | properly in | 760 | 390 |
| Volume of solution (ml) | 55 | 22 | the chamber | — | 33 |
| Temperature (° C.) | 23 | 100.4 | | 50.4 | — |
| Concentration of | 390 | Amount of | 476 | Volume of the | 33 |
| CO₂ desorbed (ppm) | | CO₂ desorbed | | solution lost | |
| | | (mg) | | (ml) | |
| Energy consumed | 70 | CO₂ unloading (mole | | 0.22 | |
| during Desorption | | CO₂/mole L-arg) | | | |
| (Wh) | | | | | |

TABLE 11
Experimental data of fifth absorption-desorption cycle of H₂O-PG-Arg solution.
Cycle 5

| | Concentration | | | Solution | |
|---|---|---|---|---|---|
| Absorption 1 | of CO₂ (ppm) | RH (%) | TVOC (ppb) | volume (ml) | pH |
| Initial | 1045 | 50.8 | 358 | 55 | 10 |
| Final | 610 | 100 | 1664 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 435 | 531 | 0.24 | 1.15 | 6 | 771 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 389 | — | properly in | 752 | 363 |
| Volume of solution (ml) | 55 | 25 | the chamber | — | 30 |
| Temperature (° C.) | 22.4 | 96.7 | | 48.3 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 752 | — | properly in | 783 | 31 |
| Volume of solution (ml) | 25 | 19 | the chamber | — | 6 |
| Temperature (° C.) | 48.3 | 100 | | 46.4 | — |
| Concentration of | 394 | Amount of | 481 | Volume of the | 36 |
| CO₂ desorbed | | CO₂ desorbed | | solution lost | |
| (ppm) | | (mg) | | (ml) | |
| Energy consumed | 100 | CO₂ unloading (mole | | 0.22 | |
| during Desorption | | CO₂/mole L-arg) | | | |
| (Wh) | | | | | |

TABLE 12
Experimental data of sixth absorption-desorption cycle of H₂O-PG-Arg solution.
Cycle 6

| | Concentration | | | Solution | |
|---|---|---|---|---|---|
| Absorption 1 | of CO₂ (ppm) | RH (%) | TVOC (ppb) | volume (ml) | pH |
| Initial | 1077 | 52.8 | 331 | 55 | 10 |
| Final | 668 | 98.4 | 855 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 409 | 499 | 0.23 | 1.21 | 6 | 530 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 378 | — | properly in | 725 | 347 |
| Volume of solution (ml) | 55 | 27 | the chamber | — | 28 |
| Temperature (° C.) | 22.4 | 97.9 | | 52.7 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 725 | — | properly in | 757 | 32 |
| Volume of solution (ml) | 27 | 21 | the chamber | — | 6 |
| Temperature (° C.) | 52.7 | 100 | | 50.4 | — |
| Concentration of | 379 | Amount of | 463 | Volume of the | 34 |
| CO₂ desorbed (ppm) | | CO₂ desorbed | | solution lost | |
| | | (mg) | | (ml) | |
| Energy consumed | 100 | CO₂ unloading (mole | | 0.21 | |
| during Desorption | | CO₂/mole L-arg) | | | |
| (Wh) | | | | | |

TABLE 13
Experimental data of seventh absorption-desorption cycle of H₂O-PG-Arg solution.
Cycle 7

| | Concentration | | | Solution | |
|---|---|---|---|---|---|
| Absorption 1 | of CO₂ (ppm) | RH (%) | TVOC (ppb) | volume (ml) | pH |
| Initial | 1035 | 58.1 | 335 | 55 | 10 |
| Final | 704 | 100 | 845 | 49 | 9 |

| Concentration of | Amount of | CO₂ loading | Rate constant | Volume of the | Absorption |
|---|---|---|---|---|---|
| CO₂ absorbed | CO₂ absorbed | (Mole CO₂/ | (K″ × 10⁻⁶) | solution lost | run time |
| (ppm) | (mg) | mole L-arg.) | (ppm⁻¹ min⁻¹) | (ml) | (min) |
| 331 | 404 | 0.18 | 1.10 | 6 | 603 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 367 | — | properly in | 708 | 341 |
| Volume of solution (ml) | 55 | 22 | the chamber | — | 33 |
| Temperature (° C.) | 22.8 | 97.3 | | 46.7 | — |
| Concentration of | 341 | Amount of | 416 | Volume of the | 33 |
| CO₂ desorbed | | CO₂ desorbed | | solution lost | |
| (ppm) | | (mg) | | (ml) | |
| Energy consumed | 70 | CO₂ unloading (mole | | 0.19 | |
| during Desorption | | CO₂/mole L-arg) | | | |
| (Wh) | | | | | |

TABLE 14
Experimental data of eight absorption-desorption cycle of H₂O-PG-Arg solution.
Cycle 8

| | Concentration | | | Solution | |
|---|---|---|---|---|---|
| Absorption 1 | of CO₂ (ppm) | RH (%) | TVOC (ppb) | volume (ml) | pH |
| Initial | 1098 | 52.9 | 349 | 55 | 10 |
| Final | 746 | 100 | 1197 | 49 | 9 |

| Concentration | Amount | | Rate | | |
|---|---|---|---|---|---|
| of CO₂ | of CO₂ | CO₂ loading | constant | Volume of | Absorption |
| absorbed | absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 352 | 430 | 0.20 | 1.02 | 6 | 740 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 381 | — | properly in | 710 | 329 |
| Volume of solution | 55 | 18 | the chamber | — | 37 |
| (ml) | | | | | |
| Temperature (° C.) | 22.6 | 94.8 | | 47 | — |
| Concentration of | 329 | Amount of | 402 | Volume of | 37 |
| CO₂ desorbed | | CO₂ desorbed | | the solution | |
| (ppm) | | (mg) | | lost (ml) | |

| | | | |
|---|---|---|---|
| Energy consumed | 70 | CO₂ unloading | 0.18 |
| during Desorption | | (mole CO₂/ | |
| (Wh) | | mole L-arg) | |

TABLE 15
Experimental data of ninth absorption-desorption cycle of H₂O-PG-Arg solution.
Cycle 9

| | Concentration | | | Solution | |
|---|---|---|---|---|---|
| Absorption 1 | of CO₂ (ppm) | RH (%) | TVOC (ppb) | volume (ml) | pH |
| Initial | 1079 | 53.1 | 337 | 55 | 10 |
| Final | 747 | 97.2 | 1073 | 49 | 9 |

| Concentration | Amount | | Rate | | |
|---|---|---|---|---|---|
| of CO₂ | of CO₂ | CO₂ loading | constant | Volume of | Absorption |
| absorbed | absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 332 | 405 | 0.18 | 1.24 | 6 | 460 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 357 | — | properly in | 657 | 300 |
| Volume of solution | 55 | 20 | the chamber | — | 35 |
| (ml) | | | | | |
| Temperature (° C.) | 22.6 | 97.9 | | 45.4 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 657 | — | properly in | 684 | 27 |
| Volume of solution | 20 | 13 | the chamber | — | 7 |
| (ml) | | | | | |
| Temperature (° C.) | 45.4 | 97.1 | | 43 | — |
| Concentration of | 327 | Amount of | 399 | Volume of | 42 |
| CO₂ desorbed (ppm) | | CO₂ desorbed | | the solution | |
| | | (mg) | | lost (ml) | |
| Energy consumed | 100 | CO₂ unloading | | 0.18 | |
| during Desorption | | (mole CO₂/ | | | |
| (Wh) | | mole L-arg) | | | |

TABLE 16
Experimental data of tenth absorption-desorption cycle of H₂O-PG-Arg solution.
Cycle 10

| | Concentration | | | Solution | |
|---|---|---|---|---|---|
| Absorption 1 | of CO₂ (ppm) | RH (%) | TVOC (ppb) | volume (ml) | pH |
| Initial | 1054 | 54.9 | 314 | 55 | 10 |
| Final | 740 | 100 | 1048 | 49 | 9 |

| Concentration | Amount | | Rate | | |
|---|---|---|---|---|---|
| of CO₂ | of CO₂ | CO₂ loading | constant | Volume of | Absorption |
| absorbed | absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 314 | 383 | 0.17 | 0.92 | 6 | 556 |

Desorption 1

| Desorption step 1 | Microwave desorption time -150 sec | | | | |
|---|---|---|---|---|---|
| HPL - 10 | Initial | After | 5 min wait | Final | Difference |
| | | desorption | for air to | | |
| Conc. of CO₂ (ppm) | 361 | — | mix | 655 | 294 |
| Volume of solution | 55 | 23 | properly in | — | 32 |
| (ml) | | | | | |
| Temperature (° C.) | 22.8 | 95 | the chamber | 47.3 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 655 | — | properly in | 681 | 26 |
| Volume of solution | 23 | 13 | the chamber | — | 10 |
| (ml) | | | | | |
| Temperature (° C.) | 47.3 | 96.4 | | 44.6 | — |
| Concentration of | 320 | Amount of | 391 | Volume of | 42 |
| CO₂ desorbed (ppm) | | CO₂ desorbed | | the solution | |
| | | (mg) | | lost (ml) | |

| | | | |
|---|---|---|---|
| Energy consumed | 100 | CO₂ unloading | 0.18 |
| during Desorption | | (mole CO₂/ | |
| (Wh) | | mole L-arg) | |

TABLE 17
Experimental data of absorption-conventional
desorption cycle of aqueous MEA solution.

| | Concentration | | | Solution | |
|---|---|---|---|---|---|
| Absorption | of CO₂ (ppm) | RH (%) | TVOC (ppb) | volume (ml) | pH |
| Initial | 1037 | 53.6 | 318 | 53 | 12 |
| Final | 318 | 100 | 22795 | 49 | 9 |

| Concentration | Amount | | Microair | Volume | |
|---|---|---|---|---|---|
| of CO₂ | of CO₂ | CO₂ loading | pump power | of the | Absorption |
| absorbed | absorbed | (Mole CO₂/ | consumption | solution | run time |
| (ppm) | (mg) | Mole MEA) | (Wh) | lost (ml) | (min) |
| 719 | 878 | 0.41 | 19.9 | 7 | 871 |

| Conventional | Concentration | | | Solution | Solution |
|---|---|---|---|---|---|
| Desorption | of CO₂ (ppm) | RH (%) | TVOC (ppb) | volume (ml) | temperature (C.) |
| Initial | 361 | 55.5 | 330 | 53 | 24 |
| Final | 660 | 83.3 | 319 | 46 | 67 |

| Concentration | Amount | CO₂ | Microair | Volume | |
|---|---|---|---|---|---|
| of CO₂ | of CO₂ | unloading | pump power | of the | Desorption |
| desorbed | desorbed | (Mole CO₂/ | consumption | solution | run time |
| (ppm) | (mg) | Mole MEA) | (Wh) | lost (ml) | (min) |
| 299 | 365 | 0.17 | 3.2 | 7 | 140 |

| | |
|---|---|
| Energy consumed by hot plate during Desorption (Wh) | 100 |

Additional Data
Temperature set value of hot plate: 250 C, Sand preheating duration: 60 mins, Energy Consumed by hot plate during pre-heating: 50 Whr., Sand Temperature after pre-heating: 125 C, and Micro air pump power: 1.37 W.

TABLE 18
Experimental data of first absorption-desorption cycle of aqueous MEA solution.
Cycle 1

| | Concentration | | | Solution | |
|---|---|---|---|---|---|
| Absorption 1 | of CO₂ (ppm) | RH (%) | TVOC (ppb) | volume (ml) | pH |
| Initial | 1080 | 58.5 | 285 | 53 | 12 |
| Final | 376 | 100 | 27090 | 45 | 9 |

| Concentration | Amount | | | | |
|---|---|---|---|---|---|
| of CO₂ | of CO₂ | CO₂ loading | Rate constant | Volume of | Absorption |
| absorbed | absorbed | (Mole CO₂/ | (K″ × 10⁻⁶) | the solution | run time |
| (ppm) | (mg) | mole L-arg.) | (1/ppm min) | lost (ml) | (mins) |
| 704 | 860 | 0.40 | 2.57 | 8 | 819 |

Desorption 1

| Desorption step 1 | Microwave desorption time - 60 sec | | | | |
|---|---|---|---|---|---|
| HPL - 10 | Initial | After | 5 min wait | Final | Difference |
| | | desorption | for air to mix | | |
| Conc. of CO₂ (ppm) | 326 | — | properly in | 830 | 504 |
| Volume of solution | 53 | 27 | the chamber | — | 26 |
| (ml) | | | | | |
| RH (%) | 59.8 | — | | 100 | — |
| TVOC (ppb) | 336 | | | 78611 | |
| Temperature (C.) | 22.3 | 95.1 | | 47 | |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 830 | — | properly in | 918 | 88 |
| Volume of solution | 27 | 19 | the chamber | — | 8 |
| (ml) | | | | | |
| RH (%) | 100 | — | | 100 | — |
| TVOC (ppb) | 78611 | | | 78592 | |
| Temperature (C.) | 47 | 93 | | 43.1 | |
| Desorption step 3 | Microwave desorption time - 60 sec | | | | |
| HPL - 10 | Initial | After | 5 min wait | Final | Difference |
| | | desorption | for air to mix | | |
| Conc. of CO₂ (ppm) | 918 | — | properly in | 980 | 62 |
| Volume of solution | 19 | 10 | the chamber | — | 9 |
| (ml) | | | | | |
| RH (%) | 100 | — | | 100 | — |
| TVOC (ppb) | 78592 | | | 78615 | |
| Temperature (C.) | 43.1 | 94 | | 43 | |
| Concentration of CO₂ | 654 | Amount of | 799 | Volume of the | 43 |
| desorbed (ppm) | | CO₂ desorbed | | solution lost | |
| | | (mg) | | (ml) | |

| | | | |
|---|---|---|---|
| Energy consumed | 130 | CO₂ unloading | 0.37 |
| during Desorption | | (mole CO₂/ | |
| (Wh) | | mole MEA) | |

TABLE 19
Experimental data of second absorption-desorption
cycle of aqueous MEA solution.
Cycle 2

| | Concentration | | | Solution | |
|---|---|---|---|---|---|
| Absorption 2 | of CO₂ (ppm) | RH (%) | TVOC (ppb) | volume (ml) | pH |
| Initial | 1058 | 57.8 | 324 | 53 | 10 |
| Final | 515 | 100 | 18340 | 45 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 543 | 663 | 0.31 | 2.33 | 8 | 816 |

Desorption 2

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 363 | — | properly in | 890 | 527 |
| Volume of solution | 53 | 27 | the chamber | — | 26 |
| (ml) | | | | | |
| RH (%) | 57.9 | — | | 100 | — |
| TVOC (ppb) | 310 | | | 67155 | |
| Temperature (C.) | 22.2 | 93.6 | | 55 | |
| Concentration of | 527 | Amount of | 644 | Volume of | 26 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.30 |
| during Desorption | | (mole CO₂/ | |
| (Wh) | | mole MEA) | |

TABLE 20
Experimental data of third absorption-desorption cycle of aqueous MEA solution.
Cycle 3

| | Concentration | | | Solution | |
|---|---|---|---|---|---|
| Absorption 3 | of CO₂ (ppm) | RH (%) | TVOC (ppb) | volume (ml) | pH |
| Initial | 1053 | 61.1 | 343 | 53 | 10 |
| Final | 584 | 100 | 24576 | 45 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 469 | 573 | 0.26 | 2.04 | 8 | 720 |

Desorption 3

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 377 | — | properly in | 889 | 512 |
| Volume of solution | 53 | 25 | the chamber | — | 28 |
| (ml) | | | | | |
| RH (%) | 56.8 | — | | 100 | — |
| TVOC (ppb) | 292 | | | 55984 | |
| Temperature (C.) | 22.1 | 95.6 | | 47.5 | |
| Concentration of | 512 | Amount of | 625 | Volume of | 28 |
| CO₂ desorbed | | CO₂ desorbed | | the solution | |
| (ppm) | | (mg) | | lost (ml) | |

| | | | |
|---|---|---|---|
| Energy consumed | 70 | CO₂ unloading | 0.29 |
| during Desorption | | (mole CO₂/ | |
| (Wh) | | mole MEA) | |

TABLE 21
Experimental data of fourth absorption-desorption
cycle of aqueous MEA solution.
Cycle 4

| | Concentration | | | Solution | |
|---|---|---|---|---|---|
| Absorption 4 | of CO₂ (ppm) | RH (%) | TVOC (ppb) | volume (ml) | pH |
| Initial | 1061 | 59.2 | 307 | 53 | 10 |
| Final | 591 | 100 | 9271 | 45 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 470 | 574 | 0.27 | 1.8 | 8 | 611 |

Desorption 4

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 397 | — | properly in | 899 | 502 |
| Volume of solution | 53 | 26 | the chamber | — | 27 |
| (ml) | | | | | |
| RH (%) | 57.4 | — | | 100 | — |
| TVOC (ppb) | 350 | | | 52773 | |
| Temperature (C.) | 23 | 93.7 | | 48.7 | |
| Concentration of | 502 | Amount of | 613 | Volume of | 27 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.28 |
| during Desorption | | (mole CO₂/ | |
| (Wh) | | mole MEA) | |

TABLE 22
Experimental data of fifth absorption-desorption cycle of aqueous MEA solution.
Cycle 5

| | Concentration | | | Solution | |
|---|---|---|---|---|---|
| Absorption 5 | of CO₂ (ppm) | RH (%) | TVOC (ppb) | volume (ml) | pH |
| Initial | 1052 | 61.2 | 356 | 53 | 10 |
| Final | 549 | 100 | 14937 | 47 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole L-arg.) | (1/ppm min) | lost (ml) | (mins) |
| 503 | 614 | 0.28 | 2.11 | 6 | 570 |

Desorption 5

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 369 | — | properly in | 830 | 461 |
| Volume of solution | 53 | 25 | the chamber | — | 28 |
| (ml) | | | | | |
| RH (%) | 57.2 | — | | 100 | — |
| TVOC (ppb) | 346 | | | 61771 | |
| Temperature (C.) | 22.2 | 95.1 | | 47 | |
| Desorption step 2 | Microwave desorption time - 60 sec | | | | |
| HPL - 10 | Initial | After | 5 min wait | Final | Difference |
| | | desorption | | | |
| Conc. of CO₂ (ppm) | 830 | — | for air to | 875 | 45 |
| Volume of solution | 25 | 18 | mix | — | 7 |
| (ml) | | | | | |
| RH (%) | 100 | — | properly in | 100 | — |
| TVOC (ppb) | 61771 | | the chamber | 72019 | |
| Temperature (C.) | 47 | 94.9 | | 46.2 | |
| Concentration of | 506 | Amount of | 618 | Volume of | 35 |
| CO₂ desorbed | | CO₂ desorbed | | the solution | |
| (ppm) | | (mg) | | lost (ml) | |

| | | | |
|---|---|---|---|
| Energy consumed | 100 | CO₂ unloading | 0.29 |
| during Desorption | | (mole CO₂/ | |
| (Wh) | | mole MEA) | |

TABLE 23
Experimental data of sixth absorption-desorption cycle of aqueous MEA solution.
Cycle 6

| | Concentration | | | Solution | |
|---|---|---|---|---|---|
| Absorption 6 | of CO₂ (ppm) | RH (%) | TVOC (ppb) | volume (ml) | pH |
| Initial | 1045 | 61.2 | 371 | 53 | 10 |
| Final | 610 | 100 | 17751 | 45 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 435 | 531 | 0.25 | 1.77 | 8 | 598 |

Desorption 6

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 362 | — | properly in | 799 | 437 |
| Volume of solution | 53 | 23 | the chamber | — | 30 |
| (ml) | | | | | |
| RH (%) | 60.5 | — | | 100 | — |
| TVOC (ppb) | 348 | | | 66449 | |
| Temperature (C.) | 22.5 | 94.3 | | 48 | |
| Concentration of | 437 | Amount of | 534 | Volume of | 30 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.25 |
| during Desorption | | (mole CO₂/ | |
| (Wh) | | mole MEA) | |

TABLE 24
Experimental data of seventh absorption-
desorption cycle of aqueous MEA solution.
Cycle 7

| | Concentration | | | Solution | |
|---|---|---|---|---|---|
| Absorption 7 | of CO₂ (ppm) | RH (%) | TVOC (ppb) | volume (ml) | pH |
| Initial | 1081 | 61 | 367 | 53 | 10 |
| Final | 694 | 100 | 6261 | 47 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 387 | 473 | 0.22 | 1.53 | 6 | 466 |

Desorption 7

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 367 | — | properly in | 780 | 413 |
| Volume of solution | 53 | 23 | the chamber | — | 30 |
| (ml) | | | | | |
| RH (%) | 57.8 | — | | 100 | — |
| TVOC (ppb) | 366 | | | 58864 | |
| Temperature (C.) | 22.5 | 93.5 | | 48.3 | |
| Concentration of | 413 | Amount of | 504 | Volume of | 30 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.23 |
| during Desorption | | (mole CO₂/ | |
| (Wh) | | mole MEA) | |

TABLE 25
Experimental data of eighth absorption-desorption
cycle of aqueous MEA solution.
Cycle 8

| | Concentration | | | Solution | |
|---|---|---|---|---|---|
| Absorption 8 | of CO₂ (ppm) | RH (%) | TVOC (ppb) | volume (ml) | PH |
| Initial | 1062 | 59.1 | 367 | 53 | 10 |
| Final | 697 | 100 | 16807 | 47 | 9 |

| Concentration | Amount | CO₂ | Rate | | |
|---|---|---|---|---|---|
| of CO₂ | ofCO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 365 | 446 | 0.21 | 1.7 | 8 | 553 |

Desorption 8

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 361 | — | properly in | 766 | 405 |
| Volume of solution | 53 | 23 | the chamber | — | 30 |
| (ml) | | | | | |
| RH (%) | 59.5 | — | | 100 | — |
| TVOC (ppb) | 460 | | | 78630 | |
| Temperature (C.) | 22.6 | 94 | | 45 | |
| Concentration of | 405 | Amount of | 495 | Volume of | 30 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.23 |
| during Desorption | | (mole CO₂/ | |
| (Wh) | | mole MEA) | |

TABLE 26
Experimental data of ninth absorption-desorption cycle of aqueous MEA solution.
Cycle 9

| | Concentration | | | Solution | |
|---|---|---|---|---|---|
| Absorption 9 | of CO₂ (ppm) | RH (%) | TVOC (ppb) | volume (ml) | pH |
| Initial | 1079 | 56.5 | 437 | 53 | 10 |
| Final | 705 | 100 | 10982 | 47 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 374 | 457 | 0.21 | 1.5 | 6 | 426 |

Desorption 9

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 378 | — | properly in | 760 | 382 |
| Volume of solution | 53 | 27 | the chamber | — | 26 |
| (ml) | | | | | |
| RH (%) | 58.9 | — | | 100 | — |
| TVOC (ppb) | 481 | | | 78649 | |
| Temperature (C.) | 22.8 | 94.7 | | 46.7 | |
| Concentration of | 382 | Amount of | 466 | Volume of | 26 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.22 |
| during Desorption | | (mole CO₂/ | |
| (Wh) | | mole MEA) | |

TABLE 27
Experimental data of tenth absorption-desorption cycle of aqueous MEA solution.
Cycle 10

| | Concentration | | | Solution | |
|---|---|---|---|---|---|
| Absorption 10 | of CO₂ (ppm) | RH (%) | TVOC (ppb) | volume (ml) | PH |
| Initial | 1045 | 61.8 | 411 | 53 | 10 |
| Final | 723 | 100 | 8826 | 46 | 9 |

| Concentration | Amount | CO₂ | Rate | | |
|---|---|---|---|---|---|
| of CO₂ | of CO₂ | loading | constant | Volume of | Absorption |
| absorbed | absorbed | (Mole CO₂/ | (K″ × 10⁻⁶) | the solution | run time |
| (ppm) | (mg) | mole MEA | (1/ppm min) | lost (ml) | (mins) |
| 322 | 393 | 0.18 | 1.69 | 7 | 375 |

Desorption 10

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 343 | — | properly in | 664 | 321 |
| Volume of solution | 53 | 27 | the chamber | — | 26 |
| (ml) | | | | | |
| RH (%) | 59.5 | — | | 100 | — |
| TVOC (ppb) | 369 | | | 78646 | |
| Temperature (C.) | 22 | 96 | | 48.6 | |
| Concentration of | 321 | Amount of | 392 | Volume of | 26 |
| CO₂ desorbed | | CO₂ | | the solution | |
| (ppm) | | desorbed | | lost (ml) | |
| | | (mg) | | | |

| | | | |
|---|---|---|---|
| Energy consumed | 70 | CO₂ unloading | 0.18 |
| during Desorption | | (mole CO₂/ | |
| (Wh) | | mole MEA) | |

### CONCLUSION

This study evaluated seven CSS, focusing on their appearance, CO₂ absorption-desorption performance, reaction kinetics, and effects on RH levels and TVOC concentrations. Aqueous MEIA showed high CO₂ absorption and faster reaction kinetics but proved less suitable for indoor air capture due to elevated VOC emissions compared to aqueous Arg. Although the aqueous Arg solution performed better than aqueous MEA in terms of TVOC and RH control, it faced challenges with incomplete regeneration and significant solvent vaporization, limiting its use in continuous cycles. To address these issues, we introduced a water-PG-Arg solution, which demonstrated promising results by outperforming aqueous MEA in stability, safety, and long-term efficiency. The inclusion of PG effectively regulated RH during absorption and maintained the solution's liquid state during desorption. Overall, the water-PG-Arg solution exhibited consistent CO₂ absorption and reliable cyclic performance, positioning it as a viable and sustainable solution for indoor CO₂ capture. In our preliminary testing, the integration of an activated charcoal canister within the absorption setup further stabilized RH levels and reduced TVOC concentrations, as illustrated in FIGS. 10A-10B. As we progressed through the cyclic study, the water-PG-Arg solution's capacity to control RH was slowly impacted (FIG. 11A), presumably due to the loss of PG to evaporation primarily during the desorption processes, leading to a reduced mole fraction of PG in the resulting solutions, which can be attributed to a gradually lower TVOC generation (FIG. 11B) during the subsequent absorption processes.

### Example 2

CO₂ absorption was assessed with different surfactants. Foaming that occurs when the air is passed through the absorber is assessed in correlation with the use of the surfactant. One of the goals was to minimize foaming during this process in the optimization studies. Conditions that led to max absorption and least foaming have been identified (see Table 28). Least amount of foaming makes the process more sustainable, thus it is more desirable even though another formulation may show higher absorption but uncontrolled foaming.

### Absorption

The CO₂ absorption experiment was conducted using a 500 mL two-neck round-bottom flask containing a CO₂ scrubbing solution. The flask was connected to a condenser to recover evaporated water and amine vapors. The entire setup was placed inside a closed steel chamber (dimensions: 32×33×36 inches) equipped with an 8V fan to ensure air mixing. CO₂ was injected from the top of the chamber until the concentration reached 1000-1100 ppm, after which air was bubbled through the solution using a micro air pump to facilitate absorption.

The experiment was conducted under lab conditions at atmospheric pressure, with an initial temperature of 25±5° C. and initial relative humidity of 55±5%. Throughout the process, changes in CO₂ concentration (ppm), RH (%), and TVOCs (ppb) inside the chamber were measured using Graywolf IQ-610 sensors and logged every 30 seconds with a Graywolf Data Logger.

Multiple formulations of CO₂ scrubbing solutions were tested, including solutions with L-arginine, MEA, with and without surfactants such as Perfluorooctanoic acid (PFOA) Sodium dodecyl sulfate (SDS), Triton X-100.

### Results

The CO₂ absorption performance was evaluated for different scrubbing solutions containing MEA (monoethanolamine) or L-arginine, with and without surfactants (PFOA, SDS, Triton X-100) in propylene glycol (PG) and water mixture. The key parameters analyzed were relative humidity (RH), total volatile organic compounds (TVOCs), and CO₂ concentration before and after the absorption process. See Table 28.

TABLE 28

| | | | Change | | | Change | | | |
|---|---|---|---|---|---|---|---|---|---|
| | Initial | Final | in | Initial | Final | in | Initial | Final | Total CO2 |
| Solution | RH | RH | RH | TVOC | TVOC | TVOC | CO2 | CO2 | Absorbed |
| MEA + PG + H2O | 34 ± 12 | 81 ± 6 | 47 ± 8 | 134 ± 59 | 2166 ± 331 | 2032 ± 331 | 1065 ± 10 | 917 ± 21 | 148 ± 20 |
| MEA + PG + H2O + | 55 ± 2 | 87 ± 2 | 32 ± 2 | 324 ± 33 | 2402 ± 468 | 2078 ± 501 | 1060 ± 8 | 737 ± 16 | 323 ± 8 |
| PFO | | | | | | | | | |
| MEA + PG + H2O + | 55 ± 2 | 88 ± 1 | 33 ± 1 | 329 ± 48 | 2727 ± 937 | 2398 ± 953 | 1066 ± 2 | 750 ± 60 | 316 ± 58 |
| SDS | | | | | | | | | |
| MEA + PG + H2O + | 63 ± 5 | 88 ± 1 | 25 ± 4 | 391 ± 98 | 1819 ± 689 | 1428 ± 777 | 1058 ± 7 | 665 ± 30 | 393 ± 24 |
| TritonX100 | | | | | | | | | |
| L Arginine + PG + | 57 ± 1 | 89 ± 0 | 31 ± 1 | 238 ± 44 | 5158 ± 1738 | 4920 ± 1742 | 1045 ± 10 | 923 ± 13 | 121 ± 10 |
| H2O | | | | | | | | | |
| L Arginine + PG + | 42 ± 13 | 89 ± 0 | 46 ± 13 | 246 ± 30 | 6131 ± 1560 | 5884 ± 1591 | 1060 ± 7 | 744 ± 15 | 316 ± 10 |
| H2O + PFO | | | | | | | | | |
| L Arginine + PG + | 58 ± 2 | 89 ± 0 | 30 ± 2 | 297 ± 52 | 4787 ± 1004 | 4490 ± 1048 | 1055 ± 4 | 808 ± 52 | 247 ± 50 |
| H2O + SDS | | | | | | | | | |
| L Arginine + PG + | 60 ± 1 | 89 ± 0 | 28 ± 1 | 335 ± 40 | 5019 ± 556 | 4683 ± 594 | 1039 ± 12 | 774 ± 17 | 265 ± 25 |
| H2O + TritonX100 | | | | | | | | | |

MEA: Monoethanolamine
SDS: Sodium Dodecyl Sulfate
PFO: Perfluorooctanoic Acid
PG: Propylene Glycol

### Discussion

MEA+PG+H₂O+Triton X-100 demonstrated the highest CO₂ absorption among all tested solutions.

The highest CO₂ absorption was observed with MEA+PG+H₂O+Triton X-100, absorbing 393±24 ppm, followed closely by MEA+PG+H₂O+PFO (323±8 ppm) and MEA+PG+H₂O+SDS (316±58 ppm).

Among the L-arginine-based solutions, L-arginine+PG+H₂O+PFO exhibited the best absorption at 316±10 ppm, followed by L-arginine+PG+H₂O+Triton X-100 (265±25 ppm) and L-arginine+PG+H₂O+SDS (247±50 ppm).

The control solutions (MEA+PG+H₂O and L-arginine+PG+H₂O) showed the lowest CO₂ absorption at 148±20 ppm and 121±10 ppm, respectively, confirming the positive effect of surfactants on absorption performance.

Solutions that led to the least amount of foaming while achieving max absorption were also identified: MEA+PG+H₂O+PFO and L Arginine+PG+H₂O+PFO.

### Desorption

A microwave heating method was used for efficient CO₂ desorption from the scrubbing solution. The CO₂-loaded solution was placed in a 500 mL conical flask and sealed within the desorption chamber. After a five-minute stabilization, initial temperature, CO₂ concentration, RH, and TVOC levels were recorded.

Desorption was performed using a Panasonic 1200 W microwave oven at Power Level 10 for a set duration. Immediately after heating, the solution temperature and volume were measured, and the flask was covered to minimize vapor loss. After a five-minute waiting period, final readings of all parameters were taken.

This step was repeated multiple times without opening the chamber to ensure complete CO₂ desorption while maintaining the solution volume, allowing for an efficient and repeatable recovery process.

Abbreviations

| | |
|---|---|
| HVAC | Heating, Ventilation, and Air Conditioning system |
| OSHA | Occupational Safety and Health Administration |
| NOAA | National Oceanic and Atmospheric Administration |
| C_{CO}_{₂} | Concentration of CO₂ |
| CSS | CO₂ scrubbing solution |
| CSA | CO₂ scrubbing agent |
| MW | Microwave |
| TVOCs | Total Volatile Organic Compounds |
| RH | Relative Humidity |
| ppm | parts per million |
| Ppb | parts per billion |
| LC-MS-QqQ | Liquid Chromatography Mass Spectroscopy triple |
| | quadruple |
| HS-GC-MS | Headspace Gas Chromatography Mass Spectroscopy |
| Arg | L-arginine |
| MEA | Monoethanolamine |
| PG | Propylene Glycol |
| EG | Ethylene Glycol |

### REFERENCES

Ma, J., Li, L., Wang, H., Du, Y., Ma, J., Zhang, X., and Wang, Z. (2022). Carbon Capture and Storage: History and the Road Ahead. Engineering 14, 33-43. doi: 10.1016/j.eng.2021.11.024.
Chen, H., Lu, J., and Obobisa, E. S. (2023). Striving towards 2050 net zero CO₂ emissions: How critical are clean energy and financial sectors? Heliyon 9 (12), e22705. doi: 10.1016/j.heliyon.2023.e22705.
Global Monitoring Laboratory—NOAA. (2023). Carbon Cycle Greenhouse Gases. https://gml.noaa.gov/ccgg/trends/global.html (Accessed Sep. 6, 2023).
Young, A. S., Parikh, S., Dedesko, S., Bliss, M., Xu, J., Zanobetti, A., et al. (2024). Home indoor air quality and cognitive function over one year for people working remotely during COVID-19. Build. Environ. 257, 111551. doi: 10.1016/j.buildenv.2024.111551.
Azuma, K., Kagi, N., Yanagi, U., and Osawa, H. (2018). Effects of low-level inhalation exposure to carbon dioxide in indoor environments: A short review on human health and psychomotor performance. Environ. Int. 121, 51-56. doi: 10.1016/j.envint.2018.08.059.
Jacobson, T. A., Kler, J. S., Hernke, M. T., Braun, R. K., Meyer, K. C., and Funk, W. E. (2019). Direct human health risks of increased atmospheric carbon dioxide. Nat. Sustain. 2 (8), 691-701. doi: 10.1038/s41893-019-0323-1.
Kuramochi, H., Tsurumi, R., and Ishibashi, Y. (2023). Meta-analysis of the effect of ventilation on intellectual productivity. Int. J. Environ. Res. Public Health 20 (8), 5576. doi: 10.3390/ijerph20085576.
Tsubaki, S., Furusawa, K., Yamada, H., Kato, T., Higashii, T., Fujii, S., et al. (2020). Insights into the dielectric-heating-enhanced regeneration of CO₂-rich aqueous amine solutions. ACS Sustain. Chem. Eng. 8 (36), 13593-13599. doi: 10.1021/acssuschemeng.0c05342.
Zeman, F. (2007). Energy and material balance of CO₂ capture from ambient air. Environ. Sci. Technol. 41 (21), 7558-7563. doi: 10.1021/es070874m.
Kim, Y. E., Lim, J. A., Jeong, S. K., Yoon, Y. il, Bae, S. T., and Nam, S. C. (2013). Comparison of carbon dioxide absorption in aqueous MEA, DEA, TEA, and AMP solutions. Bull. Korean Chem. Soc. 34 (3), 783-787. doi: 10.5012/bkcs.2013.34.3.783.
Zhao, H., and Baker, G. A. (2023). Functionalized ionic liquids for CO₂ capture under ambient pressure. Green Chem. Lett. Rev. 16 (1). doi: 10.1080/17518253.2022.2149280.
Lee, S. Y., and Park, S. J. (2015). A review on solid adsorbents for carbon dioxide capture. J. Ind. Eng. Chem. 23, 1-11. doi: 10.1016/j.jiec.2014.09.001.
Aronu, U. E., Svendsen, H. F., and Hoff, K. A. (2010). Investigation of amine amino acid salts for carbon dioxide absorption. Int. J. Greenhouse Gas Control 4, 771-775. doi: 10.1016/j.ijggc.2010.04.003.
Wei, D., Kotwica, D., Nardi, G., Moazezbarabadi, A., Spannenberg, A., Ludwig, R., et al. (2023). A lysine-based system for CO₂ capture and catalytic utilization to produce formates: Irreproducibility and conflicting reactivity. ChemistrySelect 8 (32), e202302307. doi: 10.1002/slct.202302307.
Masiren, E. E., and Harun, N. (2017). Comparison of different types of carbamate amine for stripping process. Chem. Eng. Trans. 56, 721-726. doi: 10.3303/CET1756121.
Lv, B., Guo, B., Zhou, Z., and Jing, G. (2015). Mechanisms of CO₂ capture into monoethanolamine solution with different CO₂ loading during the absorption/desorption processes. Environ. Sci. Technol. 49, 10728-10735. doi: 10.1021/acs.est.5b02356.
Said, R. ben, Kolle, J. M., Essalah, K., Tangour, B., and Sayari, A. (2020). A unified approach to CO₂-amine reaction mechanisms. ACS Omega 5 (40), 26125-26133. doi:10.1021/acsomega.0c03727.
Chai, S. Y. W., Ngu, L. H., and How, B. S. (2022). Review of carbon capture absorbents for CO₂ utilization. Greenhouse Gases Sci. Technol. 12 (3), 394-427. doi:10.1002/ghg.2151.
Custelcean, R. (2022). Direct air capture of CO₂ using solvents. Annu. Rev. Chem. Biomol. Eng. 13 (1), 217-234. doi: 10.1146/annurev-chembioeng.
Mai, B., Halfdan, E., Mai Lerche, B., Stenby, E. H., and Thomsen, K. (2023). CO₂ capture from flue gas using amino acid salt solutions. Downloaded from orbit.dtu.dk on. Available at: http://www.risoe.dtu.dk/Knowledge_base/publications/Reports/ris-r-1712.aspx.
Sang Sefidi, V., and Luis, P. (2019). Advanced amino acid-based technologies for CO₂ capture: A review. Ind. Eng. Chem. Res. 58 (44), 20181-20194. doi: 10.1021/acs.iecr.9b01793.
Guo, H., Li, H., and Shen, S. (2018). CO₂ capture by water-lean amino acid salts: Absorption performance and mechanism. Energy Fuels 32 (6), 6943-6954. doi: 10.1021/acs.energyfuels.8b01012.
Mahmud, N., Benamor, A., Nasser, M. S., Al-Marri, M. J., Qiblawey, H., and Tontiwachwuthikul, P. (2017). Reaction kinetics of carbon dioxide with aqueous solutions of L-Arginine, Glycine & Sarcosine using the stopped flow technique. Int. J. Greenhouse Gas Control 63, 47-58. doi: 10.1016/j.ijggc.2017.05.012.
Wei, D., Kotwica, D., Nardi, G., Moazezbarabadi, A., Spannenberg, A., Ludwig, R., et al. (2023). A lysine-based system for CO₂ capture and catalytic utilization to produce formates: Irreproducibility and conflicting reactivity. ChemistrySelect 8 (32). doi: 10.1002/slct.202302307.
Song, H. J., Park, S., Kim, H., Gaur, A., Park, J. W., and Lee, S. J. (2012). Carbon dioxide absorption characteristics of aqueous amino acid salt solutions. Int. J. Greenhouse Gas Control 11, 64-72. doi: 10.1016/j.ijggc.2012.07.019.
Pokorný, V., Lieberzeitová, E., Štejfa, V., Havlín, J., Fulem, M., and Růžička, K. (2021). Heat capacities of 1-Arginine, 1-Aspartic Acid, 1-Glutamic Acid, 1-Glutamine, and 1-Asparagine. Int. J. Thermophys. 42(11). doi: 10.1007/s10765-021-02911-z.
Sengwa, R. J. (2003). A comparative dielectric study of ethylene glycol and propylene glycol at different temperatures. J. Mol. Liq. 108(1-3), 47-60. doi: 10.1016/S0167-7322(03)00173-9.
Bougie, F., and Iliuta, M. C. (2014). Stability of aqueous amine solutions to thermal and oxidative degradation in the absence and the presence of CO₂. Int. J. Greenhouse Gas Control 29, 16-21. doi: 10.1016/j.ijggc.2014.07.008.
Chanchey, A., Saiwan, C., Supap, T., Idem, R., and Tontiwachwuthikul, P. (2011). Off-gas emission in CO₂ capture process using aqueous monoethanolamine solution. Energy Procedia 4, 504-511. doi: 10.1016/j.egypro.2011.01.081.
New Jersey Department of Health. (2009). Propylene Glycol Hazardous substance Fact sheet. https://nj.gov/health/eoh/rtkweb/documents/fs/3595.pdf. [Accessed Oct. 15, 2024]
National Library of Medicine—Ethylamine. (2024). C₂H₅NH₂| CID 6341—PubChem. https://pubchem.ncbi.nlm.nih.gov/compound/Ethylamine #section=Nikkaji-Number. [Accessed Oct. 27, 2024]
National Library of Medicine—Monoethanolamine. (2024). C₂H₇NO I CID 700—PubChem. https://pubchem.ncbi.nlm.nih.gov/compound/Monoethanolamine. [Accessed Oct. 27, 2024]
Gabriel, C., Gabriel, S., Grant, E. H., Halstead, B. S. J., and Mingos, D. M. P. (1998). Dielectric parameters relevant to microwave dielectric heating. Chem. Soc. Rev. 27 (3), 213-223. doi: 10.1039/a827213z
Suleman, H., Maulud, A. S., Syalsabila, A., and Shahid, M. Z. (2020). The contribution of aqueous L-arginine salts to equilibrium carbon dioxide absorption in a co-promoter role at high pressure. Fluid Phase Equilib. 524, 112743. doi: 10.1016/j.fluid.2020.112743
Taylor, C. D. L., Klemm, A., Al-Mahbobi, L., Bradford, B. J., Gurkan, B., and Pentzer, E. B. (2024). Ionic Liquid-Glycol Mixtures for Direct Air Capture of CO₂: Decreased Viscosity and Mitigation of Evaporation Via Encapsulation. ACS Sustainable Chem. Eng. 12 (20), 7882-7893. doi: 10.1021/acssuschemeng.4c01265
McGurk, S. J., Martin, C. F., Brandani, S., Sweatman, M. B., and Fan, X. (2017). Microwave swing regeneration of aqueous monoethanolamine for post-combustion CO₂ capture. Appl. Energy 192, 126-133. doi: 10.1016/j.apenergy.2017.02.012
Garg, U., Lowry, J., and Algren, D. A. (2019). Ethylene glycol and other glycols: Analytical and interpretation issues. In Critical Issues in Alcohol and Drugs of Abuse Testing (pp. 59-69). Elsevier. doi: 10.1016/B978-O-12-815607-0.00005-8
New Jersey Department of Health. (2009). Right to Know Hazardous Substance Fact Sheet. https://nj.gov/health/eoh/rtkweb/documents/fs/3595.pdf [Accessed Oct. 31, 2024]

1. A carbon dioxide absorption composition, comprising: a solution of an amino compound in a solvent comprising water, a glycol, and a surfactant.

2. The carbon dioxide absorption composition of claim 1, wherein the glycol is selected from the group consisting of ethylene glycol, diethylene glycol propylene, triethylene glycol, propylene glycol, di-propylene glycol, and a mixture thereof.

3. The carbon dioxide absorption composition of claim 1, wherein the amino compound comprises an alkylamine, an alkanolamine, an amino acid, or a combination thereof.

4. The carbon dioxide absorption composition of claim 1, wherein the amino compound is monoethanolamine or arginine.

5. The carbon dioxide absorption composition of claim 1, wherein the ratio of water to the glycol is about 0.5:1 to about 2:1 by volume.

6. The carbon dioxide absorption composition of claim 5, wherein the ratio of water to the glycol is about 1:1 by volume.

7. The carbon dioxide absorption composition of claim 1, wherein the amino compound has a concentration of about 500 mM to about 20000 mM in the solution.

8. The carbon dioxide absorption composition of claim 1, wherein the surfactant is selected from the group consisting of perfluorooctanoic acid (PFOA), sodium dodecyl sulfate (SDS), Triton X-100, and a combination thereof.

9. The carbon dioxide absorption composition of claim 1, wherein the relative proportion of the glycol to the surfactant enhances carbon dioxide absorption.

10. The carbon dioxide absorption composition of claim 1, wherein the surfactant has a concentration of about 200 mg/L to about 500 mg/L in the solution.

11. The carbon dioxide absorption composition of claim 1, wherein the amino compound is arginine and wherein the solvent comprises water and propylene glycol in a ratio of about 1:1 by volume.

12. A device for carbon dioxide absorption, comprising:
the carbon dioxide absorption composition of claim 1; and
a chamber in which the carbon dioxide absorption composition is placed.

13. (canceled)

14. A method of removing carbon dioxide in a gas phase, the method comprising contacting the gas phase with the carbon dioxide absorption composition of claim 1, so that the carbon dioxide in the gas phase reacts with the amino compound in the carbon dioxide absorption composition to produce a carbon dioxide-enriched composition, thereby reducing content of the carbon dioxide in the gas phase.

15. (canceled)

16. (canceled)

17. A method of improving indoor air quality, the method comprising: contacting the indoor air with the carbon dioxide absorption composition of claim 1, such that the carbon dioxide in the indoor air reacts with the amino compound in the carbon dioxide absorption composition to produce a carbon dioxide-enriched composition, thereby reducing content of the carbon dioxide in the indoor air.

18. The method of claim 17, wherein a relative humidity (RH) level of the indoor air is maintained within 30%-70%.

19. (canceled)

20. The method of claim 17, wherein a total volatile organic compounds (TVOCs) level of the indoor air is maintained below 10 ppm.

21. (canceled)

22. The method of claim 17, further comprising passing the indoor air through activated carbon.

23. (canceled)

24. The method of claim 14, further comprising subjecting the carbon dioxide-enriched composition to microwave irradiation, thereby producing a regenerated carbon dioxide absorption composition and releasing the absorbed carbon dioxide.

25. The method of claim 24, further comprising reusing the regenerated carbon dioxide absorption composition for reaction with the carbon dioxide in the gas phase or indoor air.

26. The method of claim 24, further comprising collecting the released carbon dioxide.
